(19) United States
(12) Patent Application Publication
(10) Pub. No.: US 2011/0282253 A1
(43) Pub. Date: Nov. 17, 2011

(54) WRIST EXOSKELETON

(76) Inventors: Carlo MENON, Burnaby (CA); Kaminska Bozena, Vancouver (CA); Zhen Gang XIAO, Surrey (CA)

(21) Appl. No.: 12/887,444

(22) Filed: Sep. 21, 2010

(30) Foreign Application Priority Data
Sep. 21, 2009 (CA) 2679505

(51) Int. Cl. A61H 1/02

(52) U.S. Cl. 601/40

(57) ABSTRACT

A wrist exoskeleton is disclosed. The wrist exoskeleton includes a first means for imparting motion on a wrist of a user in a first degree of freedom corresponding to a flexion/extension of the wrist, and a second means for imparting motion on the wrist of the user in a second degree of freedom corresponding to a radial/ulnar deviation motion of the wrist. The wrist exoskeleton further includes a hand support adapted to be worn on a hand of the user corresponding to the wrist. The hand support and said first and second means for imparting motion on the wrist of the user in the first and second degrees of freedom interoperate with each other in a manner that permits the pronation and supination motion of a same forearm of the user corresponding to the wrist.

### 1. CROSS-REFERENCE TO RELATED APPLICATIONS

The present application claims priority to previously filed Canadian Patent Application Number 2,679,505 filed Sep. 21, 2009 and entitled EXOSKELETON ROBOT, the contents of which are hereby incorporated by reference in their entirety.

### 2. TECHNICAL FIELD

The present invention relates generally to a wearable, powered exoskeleton. More particularly, the present invention relates to a wrist exoskeleton adapted to be worn on the hand and forearm of a user.

### 3. BACKGROUND OF THE INVENTION

An exoskeleton is an external structural mechanism with joints and links corresponding to those of the human body. It transmits torque from actuators acting through rigid exoskeletal links to human joints.

### 4. SUMMARY OF THE INVENTION

Certain features, aspects and embodiments disclosed herein are directed to a wrist exoskeleton adapted for wearing on the wrist of a user. The wrist exoskeleton includes a first means for imparting motion on a wrist of a user in a first degree of freedom corresponding to a flexion/extension of the wrist and a second means for imparting motion on the wrist of the user in a second degree of freedom corresponding to a radial/ulnar deviation motion of the wrist. The wrist exoskeleton further includes a hand support adapted to be worn on a hand of the user corresponding to the wrist. The hand support and said first and second means for imparting motion on the wrist of the user in the first and second degrees of freedom interoperate with each other in a manner that permits the pronation and supination motion of a same forearm of the user corresponding to the wrist. Additional features, aspects and embodiments are discussed in more detail herein.

In accordance to certain embodiments, the wrist exoskeletion includes a forearm support adapted for removable attachment to at least one of a forearm and a wrist of a user. The hand support is adapted for removable attachment to a same hand of the user corresponding to the forearm. The first means for imparting motion on the wrist of the user in the first degree of freedom comprises at least one first actuator for imparting motion on the wrist of the user corresponding to the forearm in the first degree of freedom. The second means for imparting motion on the wrist of the user in the second degree of freedom comprises at least one second actuator for imparting motion on the wrist of the user in the second degree of freedom.

In some embodiments, the at least one first actuator comprises a first linear actuator rotatably mounted on a top surface of said forearm support, and the at least one second actuator comprises a second linear actuator rotatably mounted substantially on a lateral surface of said forearm support. The first and second linear actuators are configured to deliver respective first and second external forces to said hand support.

According to certain embodiments, a rotation axis of said second linear actuator is substantially aligned with a first rotation axis of said wrist of the user corresponding to the radial/ulnar deviation motion of the wrist of the user, and a rotation axis of said first linear actuator is substantially aligned with a second rotation axis of said wrist of the user corresponding to the flexion/extension motion of said wrist of the user.

In one embodiment, the at least one first actuator comprises a first linear actuator, and the at least one second actuator comprises a gear motor. The said gear motor is rotatably coupled on a first end to an arc-shaped disk mounted on a top surface of said forearm support and connected to said first linear actuator on a second end thereof. The linear actuator is rotatably coupled on a first end to said arc-shaped disk through said gear motor and mounted on said hand support on a second end thereof. When said gear motor is actuated, a corresponding torque generated thereby causes a spur gear of said gear motor to rotate about and along an arc of said arc-shaped disk and said first linear actuator to rotate about the same, whereby the first linear actuator is operable to impart said radial/ulnar deviation motion of the wrist of the user.

In another embodiment, the at least one first actuator comprises a first gear motor, and said at least one second actuator comprises a second gear motor. The first gear motor and the second gear motor are mounted on a moveable base, a first end of which is slidably engaged with and rotatable along a groove of an arc-shaped disk disposed on said forearm support. When said first gear motor is actuated, a corresponding torque generated thereby causes said moveable base to rotate about and along said groove of said arc-shaped disk, whereby a resulting motion of said moveable base is operable to impart said radial/ulnar deviation motion of the wrist of the user.

In one embodiment, the first actuator comprises a linear actuator for imparting a flexion/extension motion to the wrist of the user. Wherein said second actuator comprises a rotating disk attached to said forearm support and operable to be rotatably driven by a gear motor for imparting a radial/ulnar deviation motion to the wrist of the user. Said linear actuator is attached to said rotating disk.

In accordance to one embodiment, the first actuator comprises a first articulated link attached to said hand support and said forearm support and powered by a first linear actuator for imparting a flexion/extension motion to the wrist of the user. The second actuator comprises a second articulated link attached to said hand support and said forearm support and powered by a second linear actuator for imparting a radial/ulnar deviation motion to the wrist of the user. The second articulated link is oriented substantially perpendicularly to said first link.

In one embodiment, the wrist exoskeleton additionally comprises a forearm support adapted for removable attachment to at least one of a forearm and a wrist of a user. The hand support comprises a substantially spherical curved surface. The first and second means for imparting motion on the wrist of the user in the first and second degrees of freedom comprise a pair of first and second rotary motors with drive wheels engaging said substantially spherical curved surface of said hand support.

In another embodiment, the wrist exoskeleton additionally comprises a flexible articulating structure comprising a plurality of interconnected links extending between said hand support and said forearm support. Said first actuator comprises at least one linear actuator adapted to apply a tensile force to said plurality of interconnected links in a first direction for imparting a flexion/extension motion to the wrist of the user. Said second actuator comprises at least one linear actuator adapted to apply a tensile force to said plurality of interconnected links in a second direction for imparting a radial/ulnar deviation motion to the wrist of the user.

In accordance to another embodiment, the wrist exoskeleton additional comprises a plurality of shape memory alloy strips extending between said hand support and said forearm support. Said first actuator comprises at least one said shape memory alloy strip attached substantially on top of said forearm and hand supports adapted to apply a tensile force upon heating actuation for imparting a flexion/extension motion to the wrist of the user; and wherein said second actuator comprises at least one said shape memory alloy strip attached substantially at a side of said forearm and hand supports adapted to apply a tensile force upon heating actuation for imparting a radial/ulnar deviation motion to the wrist of the user.

In one embodiment, wrist exoskeleton additionally includes a plurality of piezoelectric and/or electroactive polymer actuator elements extending between said hand support and said forearm support. Said first actuator comprises at least one said piezoelectric and/or electroactive polymer actuator element attached substantially on top of said forearm and hand supports adapted to apply a tensile force upon electrical actuation for imparting a flexion/extension motion to the wrist of the user. Said second actuator comprises at least one said piezoelectric and/or electroactive polymer actuator element attached substantially at a side of said forearm and hand supports adapted to apply a tensile force upon electrical actuation for imparting a radial/ulnar deviation motion to the wrist of the user.

In yet another embodiment, the wrist exoskeleton additionally comprises a plurality of pairs of electromagnets installed between said hand support and said forearm support. Said first actuator comprises at least one said pair of electromagnets attached substantially on top of said forearm and hand supports adapted to apply an attractive or repulsive force upon electrical actuation for imparting a flexion/extension motion to the wrist of the user. The second actuator comprises at least one said pair of electromagnets attached substantially at a side of said forearm and hand supports adapted to apply an attractive or repulsive force upon electrical actuation for imparting a radial/ulnar deviation motion to the wrist of the user.

In accordance to one embodiment, the wrist exoskeleton additionally comprises a forearm support. The forearm support is adapted for removable attachment to at least one of a forearm and a wrist of a user and comprises an electromagnetic tile array. The hand support comprises a hinged linking bar having a ferromagnetic end portion and extending between said hand support and said electromagnetic tile array of said forearm support. The first and second means for imparting motion on the wrist of the user in the first and second degrees of freedom comprise said hinged linking bar and said electromagnetic tile array adapted for moving said electromagnetic end across said electromagnetic tile array upon electrical actuation for imparting at least one a flexion/extension motion and a radial/ulnar deviation motion to the wrist of the user. In certain embodiments, the wrist exoskeleton may additional comprise a magnetorheological fluid contained in an enclosure attached to said forearm support formed by said electromagnetic tile array and a second upper electromagnetic tile array.

In one embodiment, the first and second means for imparting motion on the wrist of the user in the first and second degrees of freedom each comprise at least one of a plurality of electromagnetic elements adapted to provide an attractive or repulsive force for imparting said motion, and one or more micro-fluidic actuators adapted to provide an contractive or expansive force for imparting said motion.

Further advantages of the invention will become apparent when considering the drawings in conjunction with the detailed description.

### 5. BRIEF DESCRIPTION OF THE DRAWINGS

The embodiments of the wrist exoskeleton according to the present invention will now be described with reference to the accompanying drawing figures, in which:

FIG. 1 illustrates a perspective view of the anatomical structures of the human wrist according to the prior art.

FIG. 1A illustrates a perspective view of a wrist exoskeleton according to a first embodiment of the invention.

FIG. 2 illustrates a perspective view of a wrist exoskeleton according to a second embodiment of the invention.

FIG. 3A illustrates a perspective view of a wrist skeleton according to a third embodiment of the invention.

FIG. 3B illustrates a perspective view of an adjustable joint in a wrist exoskeleton according to an embodiment of the invention.

FIG. 4A illustrates a side view of a cable-operated wrist exoskeleton according to an embodiment of the invention.

FIG. 4B illustrates a top view of a cable of a cable-operated wrist exoskeleton according to the embodiment shown in FIG. 4A.

FIG. 5 illustrates a perspective view of a wrist exoskeleton apparatus comprising a rotating disk, according to an embodiment of the invention.

FIG. 6 illustrates a perspective view of a wrist exoskeleton apparatus comprising a plurality of articulated links according to an embodiment of the invention.

FIG. 7 illustrates a perspective view of a wrist exoskeleton apparatus comprising a substantially spherical joint according to an embodiment of the invention.

FIG. 8 illustrates a perspective view of a wrist exoskeleton apparatus comprising a spine-like articulating structure according to an embodiment of the invention.

FIG. 9 illustrates a perspective view of a wrist exoskeleton apparatus comprising a plurality of shape memory alloy elements according to an embodiment of the invention.

FIG. 10 illustrates a perspective view of a wrist exoskeleton apparatus comprising a plurality of piezoelectric elements according to an embodiment of the invention.

FIG. 11 illustrates a perspective view of a wrist exoskeleton apparatus comprising a plurality of electromagnet elements according to an embodiment of the invention.

FIG. 12 illustrates a perspective view of a wrist exoskeleton apparatus comprising a plurality of electromagnetic tile elements according to an embodiment of the invention.

FIG. 13 illustrates a perspective view of a wrist exoskeleton apparatus comprising a magnetorheological fluid according to an embodiment of the invention.

FIG. 14 illustrates a perspective view of a wrist exoskeleton apparatus comprising a plurality of integrated electromagnet elements according to an embodiment of the invention.

FIG. 15 illustrates a perspective view of a wrist exoskeleton apparatus comprising a plurality of fluidic actuators according to an embodiment of the invention.

Like reference numerals refer to corresponding parts throughout the several views of the drawings.

### 6. DETAILED DESCRIPTION OF THE INVENTION

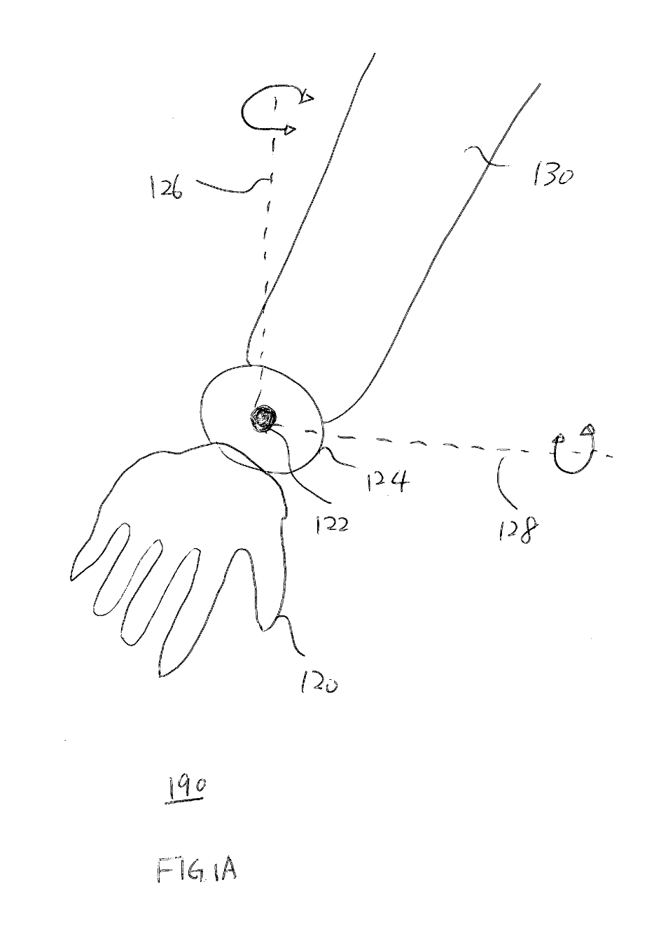

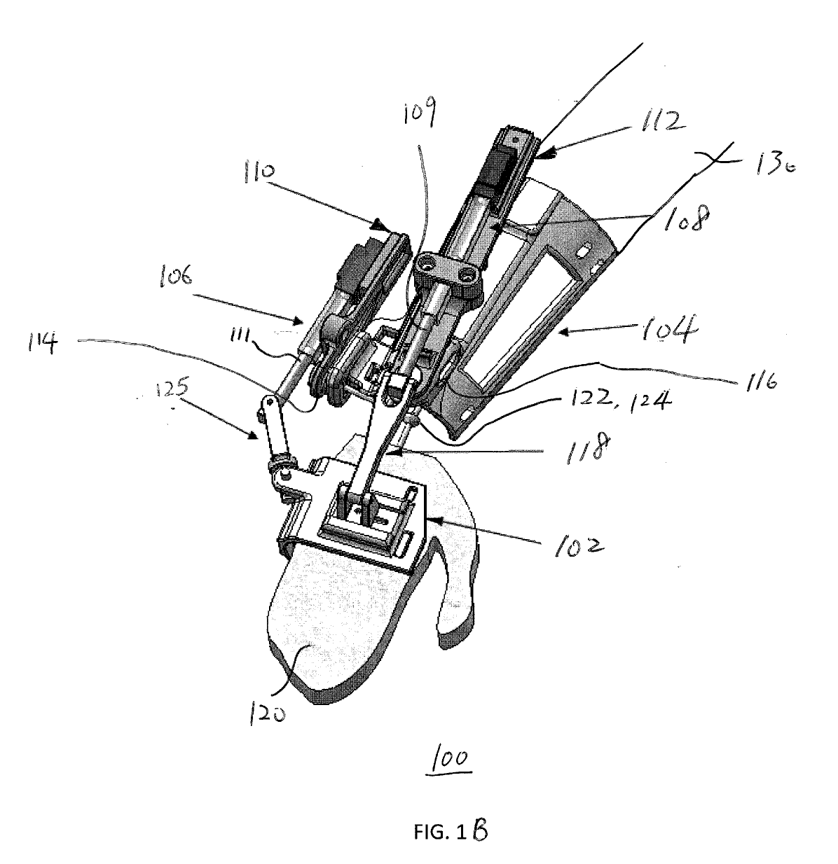

FIG. 1A illustrates a perspective view according to the prior art of the generalized anatomical skeletal structure of the relevant portions of a human upper limb 190, including a wrist joint 124, the motions of which a wrist exoskeleton apparatus according to embodiments of the present invention is adapted to control and manipulate. As shown in FIG. 1A, a human hand (e.g. right hand 120) is attached to a forearm 130 by a wrist joint 122, which corresponds to the general location of the wrist 124. Wrist joint 122 has a first rotation axis 126 corresponding to radial/ulnar deviation of the hand 120, and a second rotation axis 128 corresponding to flexion/extension of the hand 120. Both rotation axes 126 and 128 are substantially aligned with the center of the wrist joint 122 and disposed substantially perpendicular with respect to each other. The radial/ulnar deviation and flexion/extension motions or movements of the wrist joint 124 (collectively referred to and defined as the “two degrees of freedom” of movement of the wrist 124) are provided for by the rotations of the wrist 124 about the first and second rotation axes 126 and 128 respectively.

FIG. 1B illustrates a perspective view of a wrist exoskeleton 100 according to a first embodiment of the invention. Wrist exoskeleton 100 includes a forearm brace or support (e.g. forearm brace 104) adapted for removable securement or attachment to a user's forearm 130 and a hand support or brace (e.g. hand brace 102) adapted for removable securement or attachment to the user's hand 120, and/or for grasping by the user's hand 120. As shown in FIG. 1B, for example, the forearm brace 104 may be mounted for removable attachment or securement on the (extended pronated) forearm 130 of a user, and oriented generally co-planar with the palm of the user's hand 120, and the hand brace 102 may be removeably fitted over and secured to the palm of the user's hand 120. The forearm brace 104 and the hand brace 102 may be respectively attached or secured to the forearm 130 and the hand 120 by any suitable fastening means, such as a hook and loop fastening system (e.g. Velcro® straps), elastic straps, or anatomically formed rigid brackets, for example.

Referring to FIGS. 1A and 1B, the wrist exoskeleton 100 further includes means for imparting (angular) motion on the user's wrist 124 in a first degree of (rotational) freedom corresponding to a flexion/extension motion of the user's wrist about the second axis 128, and for imparting (angular) motion on the user's wrist 124 in a second degree of (rotational) freedom corresponding to a radial/ulnar deviation motion of the wrist 124 about the first rotation axis 126. In the particular embodiment as shown in FIG. 1B, the means for imparting motion on the user's wrist 124 includes at least two independent actuating means, and more particularly, at least two linear actuators (e.g. a lateral linear actuator 106 and a top linear actuator 108) mounted on the forearm brace 104 through respective intermediate rotatable base members and joints. Specifically, the top linear actuator 108 may be mounted on a top rotatable base 112, which may in turn be rotatably mounted on the forearm brace 104 through a top revolute or hinge joint 116. Similarly, the lateral linear actuator 106 may be mounted on a lateral rotatable base 110, which may in turn be rotatably mounted on the forearm brace 104 through a lateral revolute or hinge joint 114.

Still referring to FIGS. 1A and 1B, the location at which the lateral revolute joint 114 is rotatably mounted on the forearm brace 104 may desirably be selected such that the rotation axis of the lateral revolute joint 114 is coincidentally or coaxially disposed with the second rotation axis 128 of the user's wrist joint 122, whereby the rotation of the lateral revolute joint 106 about its rotation axis corresponds to the flexion/extension motion of the user's wrist 124 about the second rotation axis 128. In the embodiment as shown in FIG. 1B, for example, the lateral revolute joint 106 may be mounted laterally or on the side of the forearm brace 104 substantially proximate to the ulnar bone (not shown) of the user's forearm 130. Similarly, the location at which the top revolute joint 116 is rotatably mounted on the forearm brace 104 is selected such that the rotation axis of the top revolute joint 116 is coincidentally or coaxially disposed with the first rotation axis 128 of the wrist joint 122, whereby the rotation of the top revolute joint 106 about its axis corresponds to the radial/ulnar deviation motion of the user's wrist 124 about the first rotation axis 126. In the embodiment as shown in FIG. 1B, for example, the top revolute joint 116 may be mounted on top of the forearm brace 104.

The exoskeleton 100 further comprises a plurality of mechanical links (e.g. a top link 118 and a lateral link 125) for transferring corresponding external forces delivered by the respective top linear actuator 108 and lateral linear actuator 106 disposed on the forearm brace 104 into torque acting on the hand brace 102, to thereby cause or control the motion of the user's wrist joint 124 in the two degrees of freedom. Generally, the top link 118 and the lateral link 125 each have one end thereof pivotally connected to the respective top linear actuator 108 and the lateral linear actuator 106, and another end thereof pivotally connected to the hand brace 102, such as through revolute joints. More specifically, the top link 118 may have an upper end connected to an output rod 109 of the top linear actuator 108 and a lower end connected to the surface of a portion of the hand brace 102 oriented substantially co-planar with the palm of the user's hand 120. The top link 118 is oriented at an acute angle in relation to the length of the output rod 109, whereby the external force delivered by the output rod 109 of the top linear actuator 108 may be transferred by the top link 118 into a torque acting on the hand brace 102 to cause or control the flexion/extension motion of the user's wrist 124. Similarly, the lateral link 125 may have an upper end connected to an output rod 111 of the lateral linear actuator 106 and a lower end connected to the surface of a portion of the hand brace 102 oriented substantially perpendicular to the surface of the hand brace 102 on which the top link 118 is pivotally connected. The lateral link 125 is oriented at an acute angle in relation to the length of the output rod 111, whereby the force delivered by the output rod 111 of the lateral linear actuator 106 may be transferred by the lateral link 125 into a torque acting on the hand brace 102 to cause or control the radial/ulnar deviation motion of the user's wrist 124. Accordingly, a wrist exoskeleton capable of causing or controlling the two degrees of freedom of movement of the wrist is thereby desirably achieved, while without limiting or impeding the pronation and supination motion or movement of the user's forearm, a feature advantageous over prior art exoskeleton designs.

Operationally, to provide for the two degrees of freedom of control of the user's wrist 124, the forearm or wrist brace 104 and the hand brace 102 of the wrist skeleton apparatus 100 may be first installed on the corresponding portions of the user's forearm 130 and hand 120 for securement or attachment thereto. The forearm or wrist brace 104 and the hand brace 102 are “properly installed” on the user's respective forearm 130 and hand 120 when the rotation axes of the top revolute joint 116 and the lateral revolute joint 114 are substantially aligned to the centre of the user's wrist joint 122, and coincidentally or co-axially disposed with the respective first rotation axis 126 and second rotation axis 128 of the wrist joint 122. The linear actuators 106 and 108 may then be independently actuated to drive their respective output rods 111 and 109 in linear motion and deliver corresponding external push or pull forces to cause or control the movement of the hand brace 120 (and by extension the wrist 124 and the hand 120) about the lateral revolute joint 114 and the top revolute joint 116, thereby achieving the desired two degrees of freedom of movement of the wrist 124.

For example, when a flexion motion of the wrist 124 is desired, the top linear actuator 108 may be actuated to drive the corresponding output rod 109 to linearly extend while the lateral linear actuator 106 remains idle. The extension of the output rod 109 of the top linear actuator 108 corresponds to (or in turn provides) an external pushing force delivered to the top link 118, which in turn transfers this force into a torque acting on the hand brace 102, causing the wrist 124 to flex and rotate about the first axis 128 of the wrist joint 122 (and by extension about the rotation axis of the lateral revolution joint 114, which is substantially coaxially disposed with respective to the first rotation axis 128). Accordingly, as will be apparent from the illustrative example above, the disposition of the revolute joints 114 and 116 in substantial alignment with the centre of the wrist joint 122, and in coincidental or co-axial alignment with the respective first rotation axis 126 and second rotation axis 128 of the wrist joint 122, advantageously allows for the revolute joints 114 and 116 to move at the same rate and direction as the natural movement of the wrist 124, thereby improving the user's wearing comfort. As further illustrated by the example above, the position, force, and/or velocity of the output rods 109 and 111 of the respective top and lateral linear actuators 108 and 106 may be statically or dynamically controlled to achieve a full range of motion of the wrist 124 in the two degrees of freedom of movement, which in turn allow for extension, flexion, abduction, adduction and circumduction of the human wrist joint 122. In one embodiment of the invention, the wrist exoskeleton 100 may be configured to have a moveable range of the wrist 124 corresponding to the full range of the wrist flexion/extension motion, which is approximately +/−85° of respective rotation about the second rotation axis 128 of the wrist joint 122, and the full range of the radial/ulnar deviation motion, which is approximately +30°/−40° of respective rotation about the first rotation axis 126 of the wrist joint 122. In another embodiment, the wrist exoskeleton 100 may be designed to permit a moveable range of the wrist 124 that is about 80 percent of the full ranges of the radial/ulnar deviation and flexion/extension motions of the wrist 124, which may be advantageously adapted for everyday use to prevent injuries to the wrist 124 from excessive stretching. The moveable range of the wrist 124 may be desirably decreased (such as to about 80 percent of full range) by moving the location at which the hand brace 102 is secured or attached to the hand 102 further from the centre of the wrist joint 124 in the proximal direction, or towards the elbow joint (not shown). In other embodiments, such as those applied to providing rehabilitative movement of a user's wrist following injury or surgery for example, the moveable range of the wrist 124 may desirably be further decreased such as to 50 percent or less of the typical full range of motion, such as to correspond to decreased mobility of the user's wrist in such instances. As the rehabilitative process progresses, the moveable range of the wrist 124 may then be gradually increased for example, to correspond to healing or improvement of the mobility of the user's wrist 124 through use of the wrist exoskeleton 100.

Various types of suitable linear actuators 106 and 108 may be selected for use with the wrist exoskeleton 100, including but not limited to mechanical, hydraulic, pneumatic, and electro-mechanical actuators, for example. Depending on the application, the factors for selecting the suitable actuators may include their size, movable range, speed, power (output and consumption), efficiency and cost, for example. In one embodiment, the linear actuators 106 and 108 may be selected from miniature electrical screw-type linear actuators manufactured by Firgelli Technologies Inc. of British Columbia, Canada. For example, the Firgelli L12-50-210-12-P and Firgelli L12-100-210-12-P linear actuators, which weigh 40 g and 50 g and have strokes extendible up to 5 cm and 10 cm respectively, may be selected for use as the lateral linear actuator 106 and the top linear actuator 108, respectively.

The materials for construction of the wrist exoskeleton 100 may be selected from any suitable commercially available durable and lightweight materials, such as acrylonitrile butadiene styrene (“ABS”) plastic and polycarbonate plastic, and/or lightweight metal alloys such as aluminum and/or titanium alloys for example.

The wrist exoskeleton adapted to control a human wrist to move in the radial/ulnar deviation directions and the flexion/extension directions according to at least some embodiments of the invention may include one or more of the following applications and advantages. In one application according to an embodiment of the invention, the wrist exoskeleton 100 may be advantageously adapted to assist the movement of a user's wrist 124, such as by the amplification of the torque acting on the wrist joint naturally due to the user's muscles. An embodiment of the wrist exoskeleton 100 adapted for assisted wrist movement use may be particularly beneficial to seniors or other persons with low muscle strength and/or weakened wrist strength or control, who may find the performance of daily tasks such as the opening of a jar or grasping of a heavy object difficult due to their decreased muscle strength and/or control. A wrist exoskeleton 100 capable of delivering assisted wrist movement may therefore be useful to enable such persons (like seniors and/or the disabled or injured for example) to perform domestic applications that typically require wrist dexterity and/or strength, especially for the manipulation of tools/utensils, such as feeding using a fork or spoon, stifling with a spoon or ladle, breaking a loaf of bread with both hands, unscrewing the lid of a jar or bottle, drinking using a glass or container, combing hair, brushing teeth, drying with a towel, pouring a drink from a bottle, turning handles of a tub/sink/washbasin, tightening a belt, opening/closing a lock with keys, drying hair using a hand hair dryer, standing up from a horizontal position (e.g. bed), or carrying objects by hand, for example. A wrist exoskeleton 100 adapted for assisted wrist movement may also permit a user to increase or regain his/her quality of life, as the type of simple home/repairing and hobby work that typically require wrist motion, such as writing with a pen, turning over pages of a magazine/book, painting, using a screwdriver, sewing and knitting/crocheting, changing a light bulb, for example, may again be performed independently. In such assisted wrist movement applications, the actuation and movement of the wrist exoskeleton may desirably be controlled electronically, such as by the use of sensors such as touch or haptic sensors, or alternatively sensors capable of detecting muscle and/or nerve impulse signals from a user related to the desired movement of the user's wrist. In one such embodiment, such signals may then be used to control the actuation and motion of the wrist exoskeleton such as through a control module and/or control program which actuates the linear actuators or other actuation means of the wrist exoskeleton in order to provide the desired assistive movement to the wrist of the user.

In another application according to an embodiment of the invention, the wrist exoskeleton 100 may be advantageously adapted for hand and/or wrist rehabilitation therapy by a user who has previously lost mobility and/or control of the function of his/her wrist, such as due to a cerebrovascular accident (“CVA”), or stroke, or wrist injury, for example. The wrist exoskeleton 100 may be adapted to control the wrist to move in a certain rotation sequence corresponding to the rehabilitation therapy of the wrist to regain its strength, flexibility and mobility, allowing a user to conduct the rehabilitation therapy with the wrist exoskeleton 100 in the comfort of his or her own home. Such controlled motions of the user's wrist guided and/or powered by the wrist exoskeleton 100 may be selected by a treatment professional such as a doctor or physical therapist for example, and may be selected from any suitable movements within the functional mobility range of the user's wrist which may be beneficial for improving at least one of the strength, flexibility, mobility and/or control of the user's wrist motion through rehabilitation. It is to be understood that any of the wrist exoskeleton embodiments disclosed in accordance with the present invention may be adapted for and used for assistive and/or rehabilitative purposes such as described above.

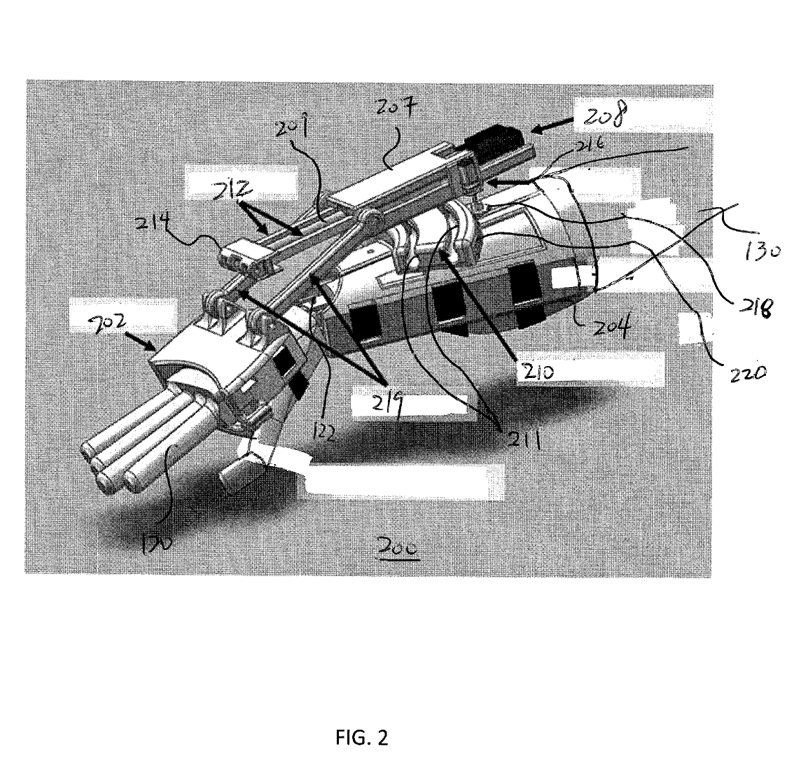

FIG. 2 illustrates a perspective view of a wrist exoskeleton 200 according to a second embodiment of the invention. Similar to the first embodiment as shown in FIG. 1B and described above, the wrist exoskeleton 200 includes a forearm brace or support (e.g. forearm brace 204) adapted for removable securement or attachment to the user's forearm 130 and a hand support or brace (e.g. hand brace 202) adapted for removable securement or attachment to the user's hand 120, and/or for grasping by the user's hand 120. As shown in FIG. 2, for example, the forearm brace 204 may be mounted for removable attachment or securement on the user's (extended pronated) forearm 130 and oriented generally co-planar with the palm of the user's hand 120, and the hand brace 202 may be removeably fitted over and secured to the palm of the user's hand 120.

Referring now to FIGS. 1A and 2, the wrist exoskeleton 200, similar to the first embodiment as shown in FIG. 1B, further includes means for imparting (angular) motion to the user's wrist 124 in a first degree of (rotational) freedom corresponding to a flexion/extension motion of the user's wrist about the second axis 128 of the wrist joint 122 and for imparting (angular) motion on the user's wrist 124 in a second degree of (rotational) freedom corresponding to a radial/ulnar deviation motion of the wrist 124 about the first axis 126. In the embodiment as shown in FIG. 2, the means for imparting motion on the user's wrist 124 in the two degrees of freedom includes at least two actuating means, and more particularly, includes one linear actuator (e.g. a top linear actuator 208 similar to the top linear actuator 108) and at least one gear motor (e.g. an electric gear motor 216) rotatably coupled to an arc-shaped disk 210. The top linear actuator 208 is slidably disposed within a moveable housing 207 which is coupled to the arc-shaped disk 210 disposed on the forearm brace 204. The top linear actuator 208 includes an output rod 209 similar to the output rod 109 of the top linear actuator 108 as shown in FIG. 1B. The output rod 209 is terminated with a block 214, which includes two rod extensions (e.g. aluminum square rods 212) disposed substantially parallel with the output rod 209 adapted for improving the stiffness of the output rod 209 during actuation. The output rod 209 and the two square rods 212 are slidably within and along the length of the moveable housing 207. The exoskeleton 200 further comprises a plurality of mechanical links (e.g. a pair of parallel bars 219) for transferring an external force delivered by the linear actuator 208 into torque acting on the hand brace 102, to thereby cause or control the flexion/extension motion of the wrist 124 about the second axis 128 of the wrist joint 122. More particularly, the parallel bars 219 each comprise one end pivotally connected to a mid section of the respective square rods 212 and another end pivotally connected to the hand brace 202. The external force delivered by the output rod 209 of the top linear actuator 208 through its sliding contraction/expansion (retraction/extension) respectively into/out of the moveable housing 207 is transferred into a torque by the parallel bars 219, which in turn causes the hand brace 202 kinematically connected thereto (and by extension the wrist 124) to extend or flex accordingly by the rotation about the second axis 128 of the wrist joint 122.

Referring now to FIG. 1A and FIG. 2, the gear motor 216 is connected to the moveable housing 207 on one end and rotatably connected to and engaging a track 220 on the outer arc of the arc-shaped disk 210 through a spur gear 218 on another end of the gear motor 216. The moveable housing 207 is slidably engaged with a plurality of sliding grooves 211 in the dorsal surface of the arc-shaped disc 210. When the gear motor 216 is actuated, the corresponding torque generated thereby causes the spur gear 218 to rotate about and along the track 219 on the outer arc of the arc-shaped disk 210, and the moveable housing 207 to travel along the sliding grooves 211 in the arc-shaped disc 210. The resulting motion of the moveable housing 207 causes or controls the radial/ulnar deviation motion of the wrist 124 by rotation about the first axis 126 of the wrist joint 122. Accordingly, providing for the two degrees of freedom of control of the user's wrist 124 may be achieved by a wrist exoskeleton 200 using a linear actuator 208 and gear motor 216 combination.

The ratio between the radius of the arc-shaped disk 210 and the spur gear 218 may be selected to achieve a desired output torque at the wrist joint 124. For example, in one embodiment, the ratio between the radius of the arc-shaped disk 210 and the spur gear 218 is 15:1. Therefore, the torque generated by the gear motor 216 is amplified by a factor of 15 at the wrist joint 124.

In one variation of the second embodiment, the dimensions of the forearm brace 204 may be approximately 19.7 cm×16.8 cm×11.1 cm and the dimensions of the hand brace 202 may be approximately 7.0 cm×12.4 cm×6.0 cm. The wrist exoskeleton 200 may be desirably designed to be lightweight for portability and ease of use while worn by a user, and in one embodiment may desirably have a total weight of no more than about 500 g including the linear actuator 208 and the gear motor 216, for example.

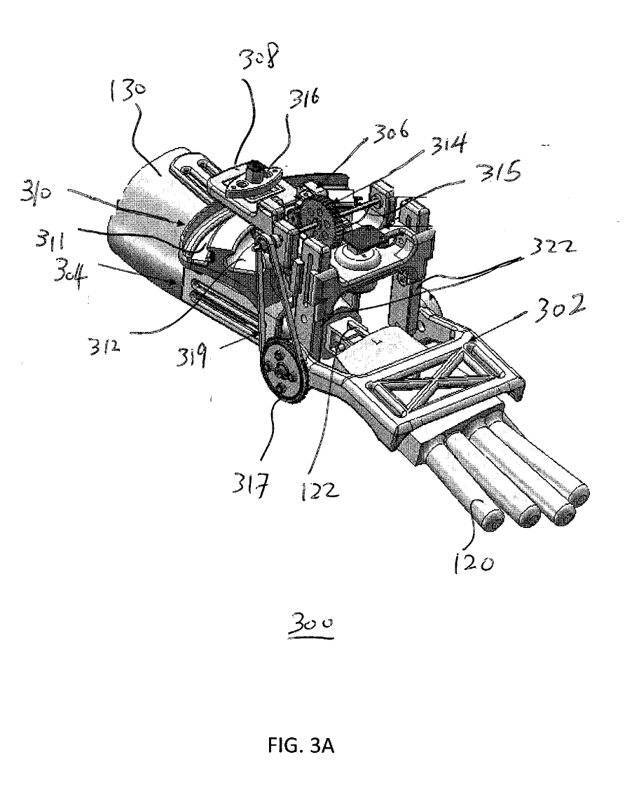

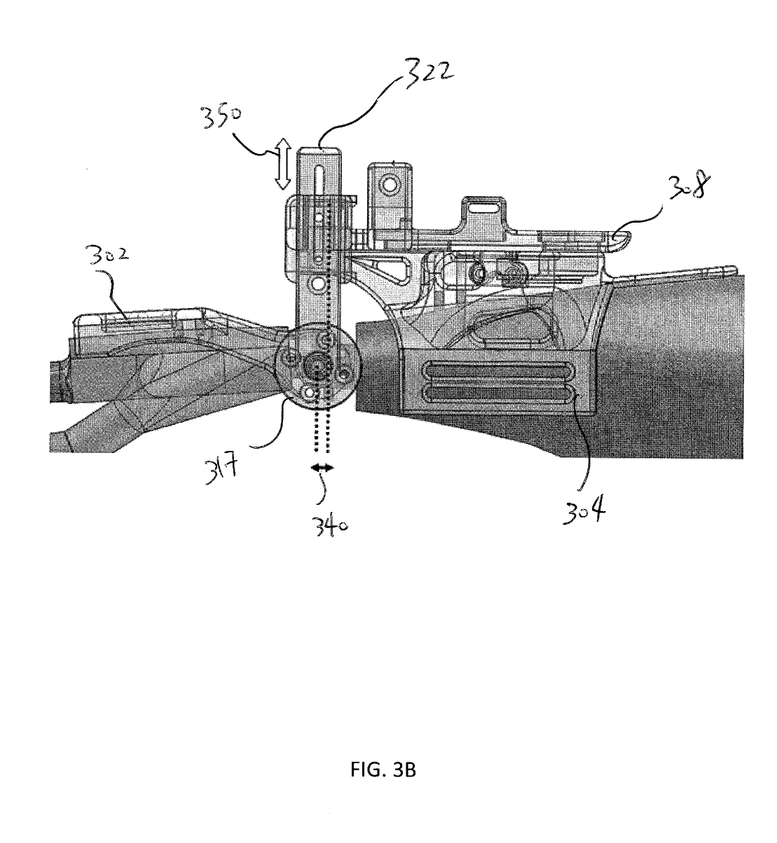

FIG. 3A illustrates a perspective view of a wrist skeleton 300 according to a third embodiment of the invention. Similar to the first embodiment as shown in FIG. 1B, the wrist exoskeleton 200 includes a forearm brace or support (e.g. forearm brace 304) adapted for removable securement or attachment to the user's forearm 130 and a hand support or brace (e.g. hand brace 302) adapted for removable securement or attachment to the user's hand 120, and/or for grasping by the user's hand 120. As shown in FIG. 3, for example, the forearm brace 304 may be mounted for removable attachment or securement on the user's (extended pronated) forearm 130 and oriented generally co-planar with the palm of the user's hand 120, and the hand brace 302 may be removeably fitted over and secured to the palm of the user's hand 120.

Referring now to FIGS. 1A and 3A, the wrist skeleton 300, similar to the second embodiment as shown in FIG. 2, further includes means for imparting (angular) motion on the user's wrist 124 in a first degree of (rotational) freedom corresponding to a flexion/extension motion of the user's wrist about the second axis 128 of the wrist joint 122 and for imparting (angular) motion on the user's wrist 124 in a second degree of (rotational) freedom corresponding to a radial/ulnar deviation motion of the wrist 124 about the first axis 126. In the embodiment as shown in FIG. 3A, the means for imparting motion on the user's wrist 124 in the two degrees of freedom includes at least two actuating means, and more particularly, includes a top gear motor 316 and a lateral gear motor 306 similar to the gear motor 216 as shown in FIG. 2.

The top or dorsal gear motor 316 is disposed on a moveable base 308 which is slidably disposed within a (outer) sliding groove 311 of an arc-shaped disk 310 and moved within the sliding groove 311 through rotation of a spur gear (not shown) disposed on the underside of the moveable base 308. Referring still to FIG. 1A and FIG. 3A, when the top gear motor 316 is actuated, the corresponding torque generated thereby causes the spur gear (not shown) disposed on the underside of the moveable base 308 (and the moveable base 308 itself) to rotate about and move along the sliding groove 311 of the arc-shaped disk 310. The resulting motion of the moveable base 308 causes or controls the radial/ulnar deviation motion of the wrist 124 by rotation about the first axis 126 of the wrist joint 122.

The ratio of the radius between the spur gear 316 and the arc-shaped disk 310 may be selected from any suitable range in order to achieve a desired torque amplification. In one embodiment, for example, the ratio of the radius between the spur gear 316 and the arc-shaped disk 310 is 1:10. The torque which is generated by the gear motor 316 will therefore be amplified by a factor of 10 at the wrist joint 122, which may correspond to a desired generated maximum torque of about 2.5 N·m for moving/controlling radial/unlar deviation of the wrist 124.

In a variation of the third embodiment, the wrist exoskeleton 300 may include two of the gear motors 316 connected in parallel and adapted to be actuated simultaneously in order to increase the output torque for the radial/ulnar deviation of the wrist 124. For example, the wrist exoskeleton 300 may further include a moveable base with a larger area than the moveable base 308 to permit the two of the gear motors 316 to be mounted thereon. The two gear motors 316 may be slidably engaged with the outer groove 311 and an inner groove 312 of the arc-shaped disk 310 respectively and actuated simultaneously to thereby achieve the desired increase in the output torque for the radial/ulnar deviation of the wrist 124.

The lateral gear motor 306 may be identical to the top gear motor 316, and is disposed on a midsection of the moveable base 308. The lateral gear motor 306 is actuated to deliver a torque to the hand brace 302 through a pair of spur gears 314 and through sprocket 317 via drive chain 319 engaged with the sprocket 317. The torque generated by the lateral gear motor 306 may be amplified through the pair of spur gears 314, resulting in an amplified torque delivered at an upper drive shaft 315 corresponding to the larger one of the spur gears pair 314. In one embodiment, the torque delivered to the upper drive shaft 315 through the spur gear pair 314 may be amplified by a factor of 3, for example. The torque delivered by the side gear motor 306 and transmitted to the upper drive shaft 315 may further be amplified through a sprocket 317 and chain 319 driven by the upper drive shaft 315, such as again by a factor of 3, for example. The sprocket 317 is connected to the hand brace 302 and has a rotation axis disposed substantially co-axially with the second axis 128 of the wrist joint 122. The torque generated by the lateral gear motor 306 and transmitted to the spur gear pair 314 is in turn transmitted to the chain 319 and sprocket 317, the latter of which causes or controls the hand brace 302 connected thereto (and by extension the wrist 124) to rotate about the second axis 128 of the wrist joint 122 in a flexion/extension motion. Accordingly, providing for the two degrees of freedom of movement and control of the user's wrist 124 may be alternatively achieved by a wrist exoskeleton 300 using two gear motors 316 and 314.

In one embodiment, another set of sprocket and corresponding drive chain may be disposed on the other side of the exoskeleton 300 and opposite from the sprocket 317 and chain 319 to similarly connect the corresponding connection links between the moveable base 308 and the hand brace 302, to thereby increase or decrease the output torque for the flexion/extension motion of the wrist 124.

Referring now to FIG. 3B, to ensure that the rotation axis of the sprocket 317 through the centre thereof coincides with the second axis 128 of the user's wrist joint 122 corresponding to a flexion/extension of the user's wrist 124, the connection links 322 between the forearm 304 and the hand brace 302 may be horizontally adjustable within a range of distance, such as within an approximately +/−5 mm range in order to account for anatomical differences in the dimensions of different user's wrists. The connection links 322 between the forearm 304 and the hand brace 302 may further be vertically adjustable within a range of distance, such as within an approximately 2 cm range to adapt the wrist exoskeleton 300 for optimal fitting on most users.

In some applications, such as when the wrist exoskeleton 300 is adapted for use by a user to perform rehabilitative exercises or tasks involving the wrist 124, the user may not be required to grasp objects with his hand 120. In such application, the wrist exoskeleton 300 may alternatively include a handle in replacement of the hand brace 302 which may be grasped by the user to provide attachment to the user's hand.

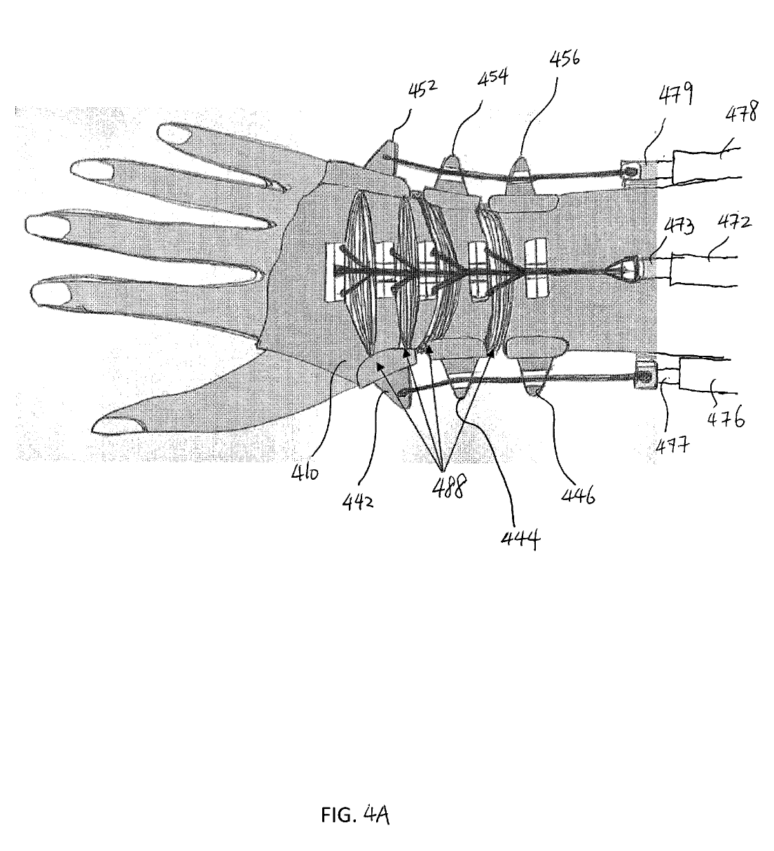

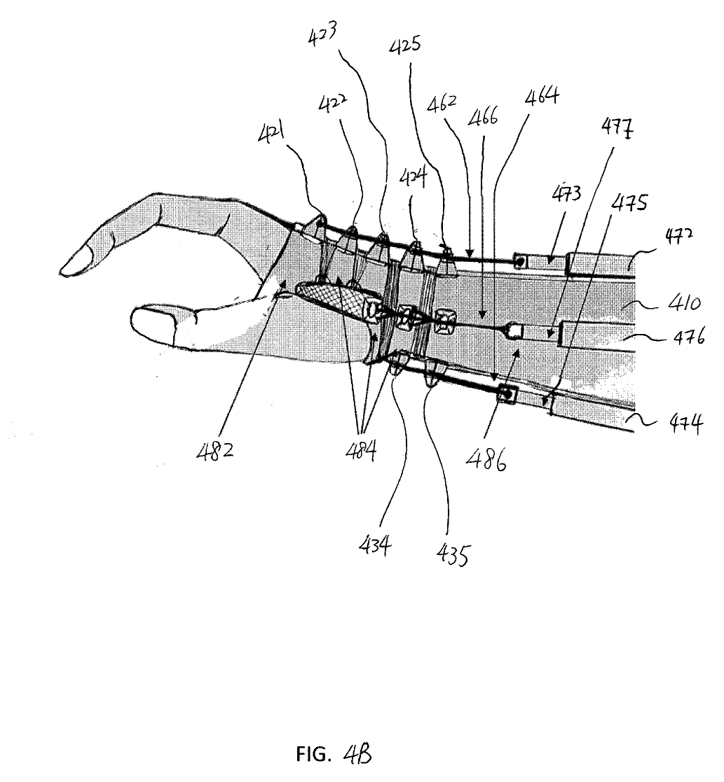

Referring now to FIGS. 4A and 4B, a top, plan or dorsal view and an elevation or side view of a wrist exoskeleton 400 are illustrated, respectively, according to a fourth embodiment of the invention. The wrist exoskeleton 400 includes a glove 410 (ideally adjustable in size) adapted to be worn on a user's palm and forearm. The glove 410 includes five defined sections, including an end section 482, three moveable sections 484, and a base section 486. The glove 410 further includes a plurality of wrinkle, accordion or corrugated structures 488 disposed in between each neighbouring two of the five defined sections. The corrugated structures 488 are deformable so as to provide allowance for the compression and expansion of the glove 410 to accommodate for the motion of the user's wrist in the two degrees of freedom. The wrist exoskeleton 400 further includes a plurality of top tiles (e.g. first to fifth top tiles 421-425) and bottom tiles (e.g. first to fifth bottom tiles 431-435) (bottom tiles 431-433 not shown) respectively connected to the top and bottom of the glove 410. The top tiles 421-425 and the bottom tiles 431-435 are connected to respective top and bottom linear actuating means (e.g. a top linear actuator 472 and a bottom linear actuator 474) through respective top and bottom tension cables 462 and 464 to thereby cause or control the respective flexion and extension motion of the user's wrist. In an alternative embodiment, the top and bottom linear actuating means may be motor powered pulleys or other suitable actuating means which may desirably be electrically controlled.

The top tiles 421-425 are mounted on the glove 410 on the top side of the user's hand and forearm. The third (centre) top tile 423 is disposed on the glove 410 at a location substantially aligned with the center of the wrist joint (not shown) of the user. The first and second top tiles 421 and 422 are spatially disposed distally, or towards the user's hand relative to the third top tile 423, and the fourth and fifth top tiles 424 and 425 are spatially disposed proximally, or towards the user's elbow relative to the third top tile 423. The top tiles 421-425 are aligned and connected to one another through the top cable 462 which terminates at the first top tile 421 at one end and the other end terminates at a the top or dorsal linear actuator 472 disposed on the glove 410 at a dorsal midsection area of the user's forearm. The linking of the top tiles 421-425 to the top linear actuator 472 provides for the extension motion of the user's wrist when an output rod 473 of the top linear actuator 472 is configured to retract, thereby applying a pulling force on the top cable 462. The user's wrist may return to its original resting position when the top linear actuator 472 extends.

The bottom tiles 431-435 are mounted on the glove 410 on the bottom, ventral or palm side of the user's hand and forearm at locations corresponding to that of the top tiles 421-425. The bottom tiles 431-435 are aligned and connected to one another through the bottom cable 464 and connected to the bottom linear actuator 474 similar to the manner of connections of the top tiles 421-425 to the top cable 462 and the top linear actuator 474. The linking of the bottom tiles 431-435 to the bottom linear actuator 474 provides for the flexion motion of the user's wrist when an output rod 475 of the bottom linear actuator 474 is configured to retract, and thereby applies a pulling force (or tensions) on the bottom cable 464.

The wrist exoskeleton 400 further includes a plurality of radial side tiles (e.g. first to third radial side tiles 442, 444, and 446) and ulnar side tiles (e.g. first to third ulnar side tiles 452, 454, and 456) respectively connected to the radial side and ulnar side of the glove 410 as worn by a user. Similar to the connection of the top tiles 421-425 and the bottom tiles 431-435 for respective wrist extension and flexion, the radial side tiles 442, 444, and 446 and ulnar side tiles 452, 454, and 456 are connected to their respective lateral actuators 476 and 478 through the respective pulling cables 476 and 478 to thereby cause or control the respective ulnar and axial deviation motion of the user's wrist accordingly in response to retraction of the lateral linear actuators 476 and 478 respectively.

The radial side tiles 442, 444, and 446 are mounted on the glove 410 laterally along the radial side of the user's hand, and on the radial side of the user's forearm. The second (centre) radial side tile 444 is disposed on the glove 410 at a location substantially aligned with the center of a wrist joint (not shown) of the user. The first and third radial side tiles 442 and 446 are respectively spatially disposed towards the hand and towards the elbow relative to the second radial side tile 444. The radial side tiles 442, 444, and 446 are aligned and connected to one another through the radial side cable 466 which has one end terminated at the first radial side tile 442 and another end terminated at a the radial side lateral linear actuator 476 disposed on the glove 410 at a midsection on the side and along the radius bone of the user's forearm. The link of the radial side tiles 442, 444, and 446 to the radial side lateral linear actuator 476 provides for the radial deviation motion of the user's wrist when an output rod 477 of the radial side lateral linear actuator 476 is configured to retract and apply a pulling force on the radial side cable 466.

The ulnar side tiles 452, 454 and 456 are mounted on the glove 410 laterally along the ulnar side of the user's hand and on the ulnar side of the forearm at locations corresponding to that of the radial side tiles 442, 444, and 446. The ulnar side tiles 452, 454 and 456 are aligned and connected to one another through the ulnar side cable 468 and connected to the ulnar side lateral linear actuator 478 similar to the manner of connections of the radial side tiles 442, 444, and 446 to the radial side cable 466 and the radial side lateral linear actuator 476. The link of the ulnar side tiles 452, 454 and 456 to the ulnar side lateral linear actuator 478 similarly provides for the ulnar deviation motion of the user's wrist when an output rod 479 of the ulnar side lateral linear actuator 478 is configured to retract and apply a pulling force on the corresponding ulnar side cable 468.

Accordingly, providing for the two degrees of freedom of control of the user's wrist may be alternatively achieved by a wrist exoskeleton 400 using four cable pulling mechanisms and mounting tiles by pulling and releasing the cables in a synchronized manner such as may be controlled in response to the user's wrist motion in an assistive motion application, or independently by a control module and/or control program as may be used in some rehabilitative applications according to embodiments of the present invention.

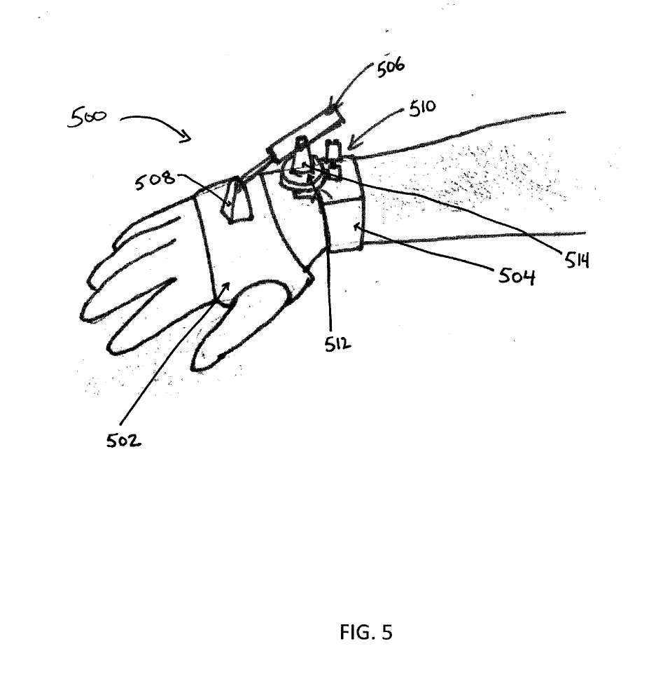

FIG. 5 illustrates a perspective view of a wrist exoskeleton apparatus 500 comprising a rotating disk 512, according to an alternative embodiment of the invention. Similar to as described in the embodiments above, wrist exoskeleton apparatus 500 comprises a hand brace member 502 and a forearm brace member 504 and provides for controlled movement of the hand brace member 502 relative to the wrist or forearm brace member 504 with two degrees of freedom. Similar to as described in embodiments above, hand brace member 502 may desirably be adapted for wearing on or around the hand of a user, while the wrist or forearm brace member 504 may be attached to or worn on the lower forearm or wrist of the user, such as slightly above (proximal to) the center of the wrist joint, such as is shown in FIG. 5. The wrist exoskeleton apparatus 500 also comprises a rotating disk or turntable 512 which is attached to the wrist or forearm brace member 504 and is located approximately over or dorsal to the center of rotation of the user's wrist joint with respect to the axis of rotation for radial/ulnar deviation movements of the user's hand relative to the forearm. The rotating disk or turntable 512 is rotatably connected to the forearm or wrist brace member 504 and is driven by a small gear motor 510 or other suitable rotary motor means which is attached to the wrist or forearm brace member 504, such as attached substantially adjacent to the disk or turntable 512, so that the gear motor 510 may rotate the disk 512 directly such as by the meshing engagement of a drive gear attached to the gear motor 510 and a driven gear incorporated into the disk or turntable element 512.

Wrist exoskeleton apparatus 500 also comprises a linear actuator 506 which is attached at its base or driving end to disk or turntable element 512 by a revolute or hinge joint 514 which may be located at the top of the disk 512 for example and hingedly movable about an axis substantially perpendicular to the longitudinal axis of the linear actuator 506, for example. The second or driven end of the linear actuator 506 is attached to the hand brace member 502 of the exoskeleton by means of a revolute or hinge joint 508 which is anchored on the hand brace element 502, such as to the top of the hand brace 502 located on the back of the user's hand. Therefore, the wrist or forearm brace element 504 is attached to the hand brace element 502 by the disk 512 and the linear actuator 506. Accordingly, when the disk element 512 is rotated by the gear motor 510, the hand brace element 502 rotates about the axis of the disk 512 corresponding to a radial/ulnar deviation movement of the hand brace 502 relative to the wrist or forearm brace 504, which may desirably produce and/or assist a radial/ulnar deviation movement of a user's hand relative to the wrist/forearm, as may be used in an assistive motion and/or rehabilitative motion application such as are described above in reference to other embodiments.

The linear actuator 506 may similarly be used to provide and control flexion/extension motion between the hand brace 502 and the wrist or forearm brace 504 resulting from the extension and retraction of the linear actuator 506, respectively. Any suitable linear actuator mechanism such as an electric gear driven linear actuator may be used to provide the desired flexion/extension motion of the wrist exoskeleton 500, as may be desirable to assist and/or control movement of a user's wrist in the flexion and extension directions.

The rotation of the gear motor 510 to provide radial/ulnar deviation movement may be desirably controlled electrically such as by a control module or other suitable electronic control means, so that the radial/ulnar deviation movement of the exoskeleton 500 may be controlled to provide a desired movement in response to inputs from the user such as for assisting a user's wrist movement or providing rehabilitative movement to the user's wrist in the radial/ulnar deviation directions, for example. The linear actuator 506 may also desirably be suitably electrically controlled to provide flexion/extension movement of the wrist exoskeleton apparatus 500, such as by any suitable electronic control means, which may also be used to control gear motor 510 and/or to control sensors or user interface devices for example, so as to integrate control of two degree of freedom movement of the wrist exoskeleton 500 and thereby also of a user's wrist, such as for assistive and/or rehabilitative applications.

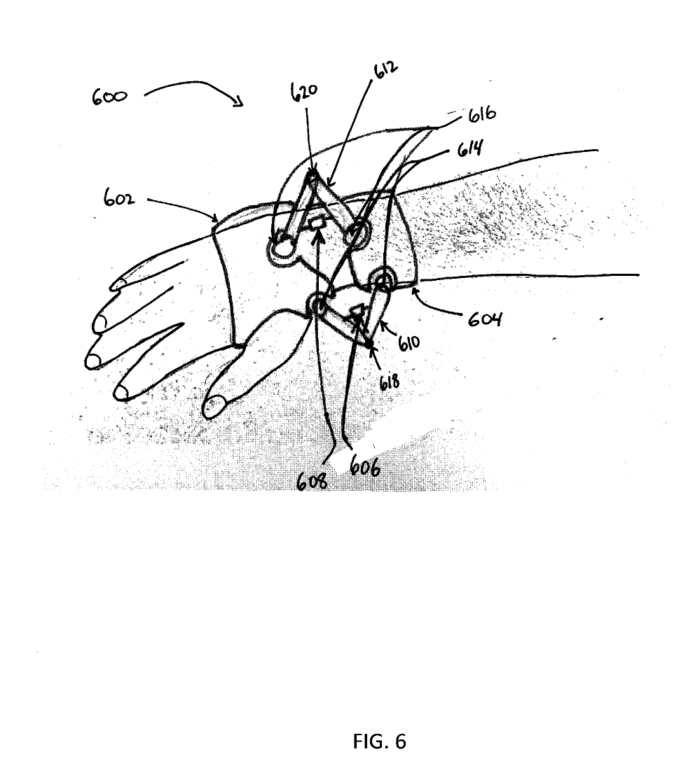

FIG. 6 illustrates a perspective view of a wrist exoskeleton apparatus 600 comprising a plurality of articulated links 610 and 612, according to an embodiment of the invention. Similar to as described in the embodiment above, wrist exoskeleton apparatus 600 comprises a hand brace member 602 and a forearm brace member 604 and provides for controlled movement of the hand brace member 602 relative to the wrist or forearm brace member 604 with two degrees of freedom corresponding to deviation in the radial/ulnar directions, and flexion/extension of the wrist joint. Similar to as described above, hand brace member 602 may desirably be adapted for wearing on or around the hand of a user, while the wrist or forearm brace member 604 may be attached to, or worn on, the lower forearm or wrist of the user, such as slightly above or proximal to the center of the wrist joint, such as is shown in FIG. 6.

The hand brace member 602 is connected to the wrist or forearm brace member 604 by a plurality of articulated links with at least one articulated link 612 located and attached along the top of the user's hand for providing motion in the flexion/extension directions, and a second articulated link 610 located substantially perpendicular to link 612 along the inside of the user's hand. The first articulated link 612 is attached to each of the hand brace member 602 and the wrist brace member 604 by means of a spherical joint 616, with a revolute or hinged joint 620 in the center of the articulated link 612. Articulated link 612 also comprises a linear actuator 608 situated between and attached to the two ends of the link 612 on either side of the joint 620, such as to provide for extending and/or retracting the articulated link 612 in response to the extension and retraction of the linear actuator 608, for example. Accordingly, the extension and retraction of the linear actuator 608 may therefore provide flexion and extension movement of the hand brace 602 relative to the wrist/forearm brace 604, respectively.

Similarly, the second articulated link 610 is attached to the hand brace member 602 and the wrist brace member 604 by means of spherical joints 614, with a revolute or hinged joint 618 in the center of the articulated link 610. Articulated link 610 also comprises a linear actuator 606 situated between and attached to the two ends of the link 610 on either side of the joint 618, such as to provide for extending and/or retracting the articulated link 610 in response to the extension and retraction of the linear actuator 606, for example. Accordingly, extension and retraction of the linear actuator 606 may therefore provide ulnar and racial deviation movement of the hand brace 602 relative to the wrist/forearm brace 604, respectively, as may be used in an assistive motion and/or rehabilitative motion application such as are described above in reference to other embodiments.

The extension and retraction of the linear actuators 606 and 608 to provide radial/ulnar deviation and flexion/extension movements of the wrist exoskeleton 600 may be desirably controlled electrically such as by a control module or other suitable electronic control means, so that the movement of the exoskeleton 600 may be controlled to provide a desired movement in response to inputs from the user such as for assisting a user's wrist movement or providing rehabilitative movement to the user's wrist with two degrees of freedom, for example.

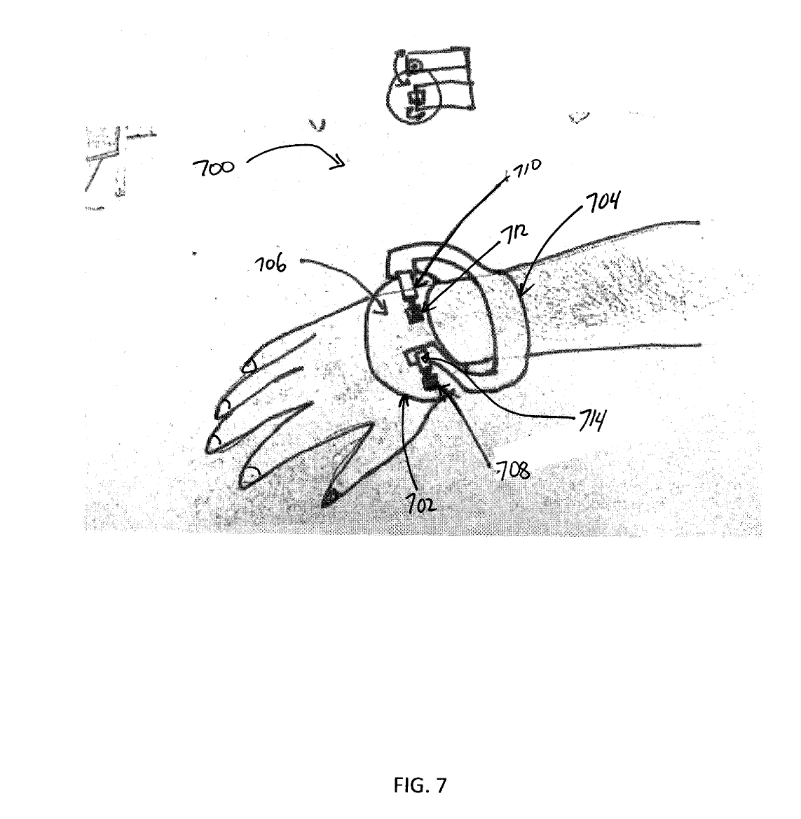

FIG. 7 illustrates a perspective view of a wrist exoskeleton apparatus 700 comprising a substantially spherical joint 706 according to a further embodiment of the invention. Similar to as described in the embodiments above, wrist exoskeleton apparatus 700 comprises a hand brace member 702 and a forearm brace member 704 and provides for controlled movement of the hand brace member 702 relative to the wrist or forearm brace member 704 with two degrees of freedom corresponding to deviation in the radial/ulnar directions, and flexion/extension of the wrist joint. Similar to as described above, hand brace member 702 may desirably be adapted for wearing or attaching on or around the hand of a user and in the present embodiment comprises a substantially spherically curved joint surface 706 which may desirably be located on the back of the user's hand, while the wrist or forearm brace member 704 may be attached to or worn on the lower forearm or wrist of the user, such as slightly above the center of the wrist joint, such as is shown in FIG. 7.

The hand brace member 702 is connected to the wrist or forearm brace member 704 by a plurality of rotary motors 710 and 714 which each comprise a rubber or other tractive drive shaft or drive wheel 712 and 708, respectively. The rubber drive shafts or drive wheels 712 and 708 are in tractive driving contact with the substantially spherical joint surface 706 so that they grip the spherical joint surface 706 and provide tractive force upon rotation of the rotary motors 710 and 714. The rotary motors 710 and 714 are disposed at the end of support arms extending from either side of the wrist brace member 704, such that drive shafts or wheels 712 and 708 contact spherical surface 706 at substantially either side of the user's wrist, such as adjacent to the thumb and small finger of the user's hand, as shown in FIG. 7.

Accordingly, if rotary motors 710 and 714 are operated in the same direction such that drive shafts or wheels 712 and 708 rotate in the same direction in contact with spherical surface 706, the tractive force exerted against surface 706 may desirably act to provide flexion/extension movement of the hand brace element 702 relative to the wrist/forearm brace element 704, depending on the direction of rotation of the drive shafts 712 and 708 by the rotary motors 710 and 714, respectively. Conversely, if drive shafts or wheels 712 and 708 rotate in different directions in contact with spherical surface 706, the tractive force exerted against surface 706 may desirably act to provide radial/ulnar deviation movement of the hand brace element 702 relative to the wrist/forearm brace element 704. Accordingly, both flexion/extension and radial/ulnar deviation movements may be provided by controlling the relative rotation directions and speeds of the rotary motors 710 and 714, which in turn control the rotation of the drive shafts/wheels 712 and 708 in contact with spherical surface 706.

The direction and speed of rotation of rotary motors 710 and 714 to provide radial/ulnar deviation and flexion/extension movements of the wrist exoskeleton 700 may be desirably controlled electrically such as by a control module or other suitable electronic control means, so that the movement of the exoskeleton 700 may be controlled to provide a desired movement in response to inputs from the user such as for assisting a user's wrist movement or providing rehabilitative movement to the user's wrist with two degrees of freedom, similar to as described above according to other embodiments of the invention.

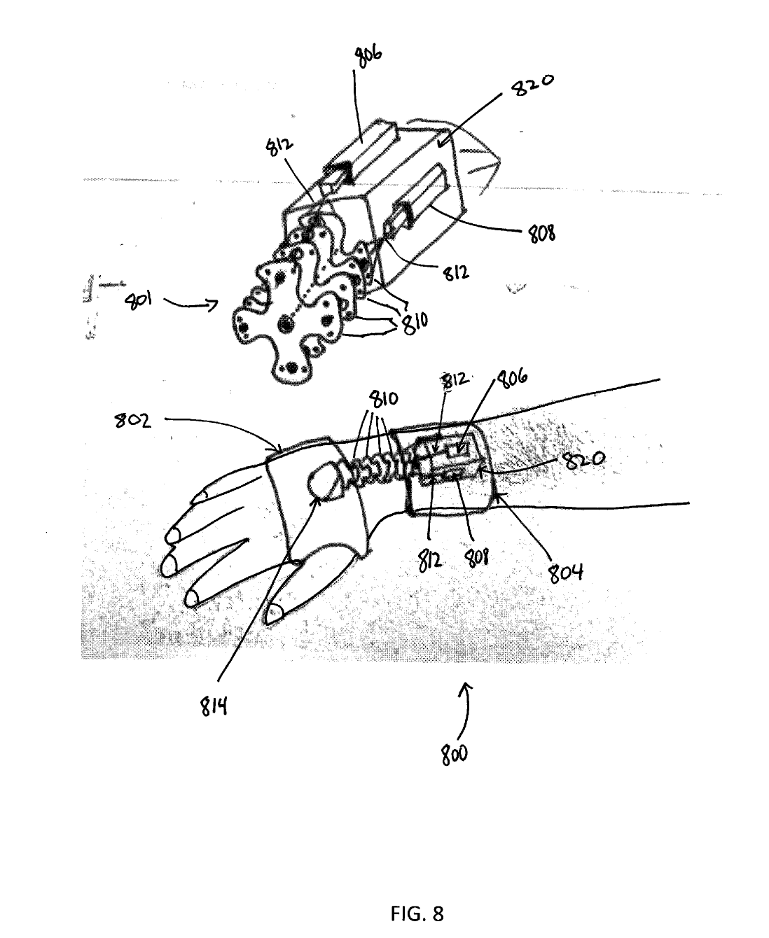

FIG. 8 illustrates a perspective view of a wrist exoskeleton apparatus 800 comprising a spine-like articulating structure 801 shown in a detailed inset view, according to an embodiment of the invention. Similar to as described in the embodiments above, wrist exoskeleton apparatus 800 comprises a hand brace member 802 and a forearm brace member 804 and provides for controlled movement of the hand brace member 802 relative to the wrist or forearm brace member 804 with two degrees of freedom corresponding to deviation in the radial/ulnar directions, and flexion/extension of the wrist joint. Similar to as above described, hand brace member 802 may desirably be adapted for wearing on or around the hand of a user, while the wrist or forearm brace member 804 may be attached to or worn on the lower forearm or wrist of the user, such as slightly above the center of the wrist joint, such as is shown in FIG. 8.

The hand brace member 802 is connected to the wrist or forearm brace member 804 by a spine-like articulating structure 801 which comprises a plurality of vertebrae-like links 810 flexibly connected at their centers such as by a cable which is connected to an end anchor 814 on hand brace element 802 at one end, and to a base module 820 on wrist/forearm member 804 at the other end. One or more wires, cables, rods or other suitable flexible tensile elements 812 are attached to a lobe on one side of each of the links 810 to provide for flexion of the articulating structure 801 to that side upon applying tension to the corresponding wire 812 by a linear actuator 806 which is mounted to the base module 820. Linear actuators 808 and wires 812 are connected to lobes on each of 4 sides of the links 810 to provide for control of movement in directions corresponding to flexion/extension of the wrist joint via linear actuators 806 above and below (not shown) the base module 820, and radial/ulnar deviation of the wrist joint via linear actuators 808 on either side of base module 820, as may be used in an assistive motion and/or rehabilitative motion applications such as are described above in reference to other embodiments.

The extension and retraction of the linear actuators 806 and 808 to provide flexion/extension and radial/ulnar deviation movements of the wrist exoskeleton 800 may be desirably controlled electrically such as by a control module or other suitable electronic control means, so that the movement of the exoskeleton 800 may be controlled to provide a desired movement in response to inputs from the user such as for assisting a user's wrist movement or providing rehabilitative movement to the user's wrist with two degrees of freedom, as shown in FIG. 8.

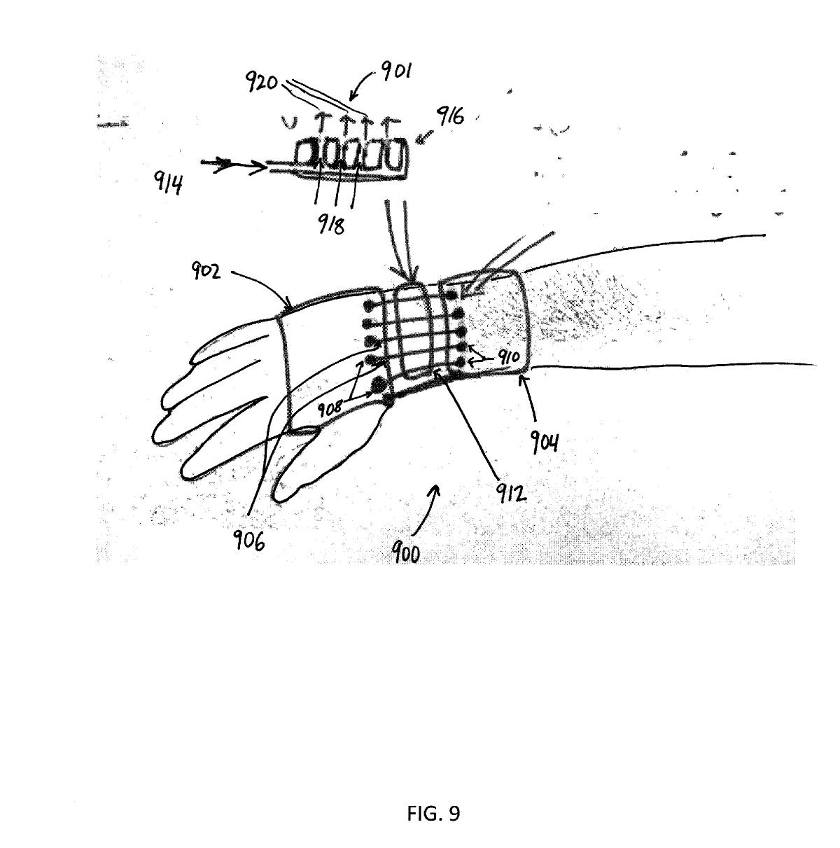

FIG. 9 illustrates a perspective view of a wrist exoskeleton apparatus 900 comprising a plurality of shape memory alloy elements 906 and an air cooling pad 912 shown in an inset view 901 according to an embodiment of the invention. Similar to as described in the embodiments above, wrist exoskeleton apparatus 900 comprises a hand brace member 902 and a wrist or forearm brace member 904 and provides for controlled movement of the hand brace member 902 relative to the wrist or forearm brace member 904 with two degrees of freedom corresponding to deviation in the radial/ulnar directions, and flexion/extension of the wrist joint.

In the present embodiment, hand brace member 902 is connected to the wrist or forearm brace member 904 by an array of shape memory alloy (SMA) strips which comprises multiple shape memory alloy strips 906 extending between a hand anchor 908 attached to the hand brace element 902, and a wrist anchor 910 attached to the wrist/forearm brace element 904. The SMA strips 906 are desirably made from a suitable shape memory alloy material which is operable to be heated by the application of an electrical current to the strips to cause an outward bend of the strip thus producing a contractive force between the corresponding two anchors, or to be cooled by passing air past the SMA strips to cause a relaxation of the strip thus returning the strip to a neutral position. Desirably, one or more SMA strips 906 may be located above and below the hand brace element 902 so that coordinated heating of upper strips and cooling of lower strips may provide extension movement of the hand brace 902, while heating of the lower strips and cooling of the upper strips may provide flexion movement of the hand brace 902. Similarly, one or more strips may desirably be located to either side of the hand brace 902 and heated and cooled in opposition so as to provide radial/ulnar deviation movement of the hand brace 902 relative to the wrist/forearm brace 904.

An air cooling pad 912 may be implemented below the SMA strips to provide a cooling flow of air to cool any SMA strips 906 not being electrically heated. Air cooling pad 912 may desirably comprise an air entry channel 914 for receiving a flow of air under pressure, which may then be directed upward to cool an SMA strip 906 located directly above the cooling pad 912, such as through vertical air passages 918 through an upper surface 916 of the cooling pad 912, to form individual air cooling jets 920 which are aligned with the SMA strips 906.

The alternate heating and cooling of the SMA strips 906 to provide flexion/extension and radial/ulnar deviation movements of the wrist exoskeleton 900 may be desirably controlled electrically such as by a control module or other suitable electronic control means that control provision of a heating electric current and cooling air flow, so that the movement of the exoskeleton 900 may be controlled to provide a desired movement in response to inputs from the user such as for assisting a user's wrist movement or providing rehabilitative movement to the user's wrist with two degrees of freedom.

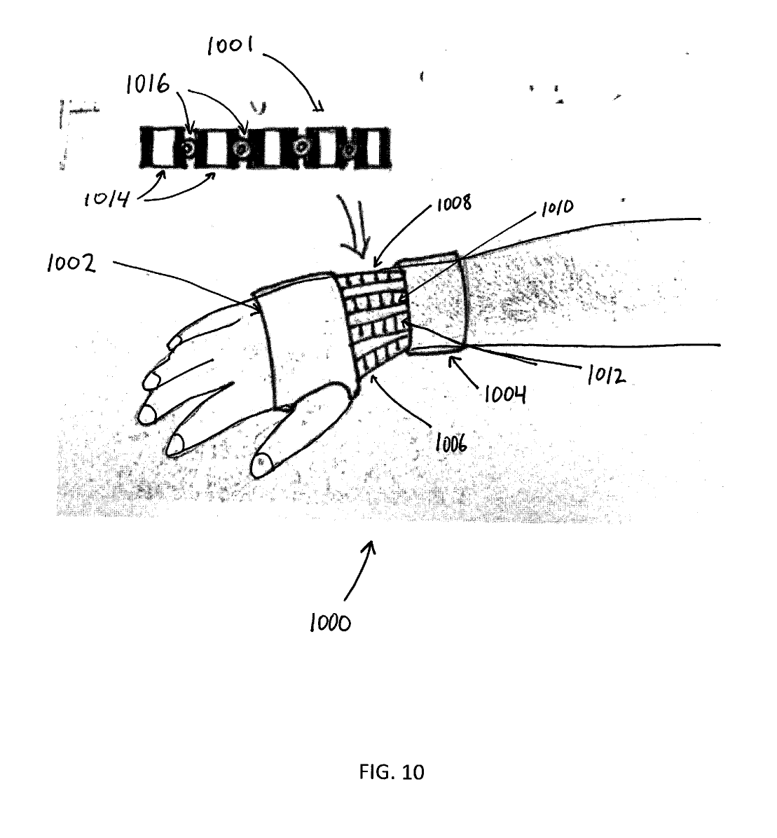

FIG. 10 illustrates a perspective view of a wrist exoskeleton apparatus 1000 comprising a plurality of piezoelectric elements 1006 according to an embodiment of the invention. Similar to as shown in the embodiment of FIG. 9 as described above, wrist exoskeleton apparatus 1000 comprises a hand brace member 1002 and a wrist or forearm brace member 1004 and provides for controlled movement of the hand brace member 1002 relative to the wrist or forearm brace member 1004 with two degrees of freedom corresponding to deviation in the radial/ulnar directions, and flexion/extension of the wrist joint.

In the present embodiment, in place of the SMA strip array used in the embodiment of FIG. 9, hand brace member 1002 is connected to the wrist or forearm brace member 1004 by a plurality of piezoelectric or electroactive polymer actuator segments 1006, 1008, 1010, 1012. As shown in detail inset view 1001, each actuator segment comprises a plurality of piezoelectric and/or electroactive polymer elements 1014, connected substantially linearly by connectors 1016 to form each actuator segment 1006, which may be contracted and/or extended (or bendingly deformed so as to result in contraction of segment 1006) by the application of an electrical voltage to the actuator, as is known for piezoelectric and electroactive polymer materials. Desirably, one or more piezoelectric and/or electroactive polymer actuator segments 1010, 1012 may be located above and below the hand brace element 1002 so that coordinated contraction/deformation of the upper actuator segment and extension/relaxation of the lower actuator segment may provide extension movement of the hand brace 1002, while contraction/deformation of the lower segment and extension/relaxation of the upper segment may provide flexion movement of the hand brace 1002. Similarly, one or more actuator segments 1006 and 1008 may desirably be located to either side of the hand brace 1002 and electrically contracted/deformed and extended/relaxed in opposition so as to provide radial/ulnar deviation movement of the hand brace 1002 relative to the wrist/forearm brace 1004.

The alternate electrical actuation of the piezoelectric and/or electroactive polymer actuator segments 1006, 1008. 1010, 1012 to provide flexion/extension and radial/ulnar deviation movements of the wrist exoskeleton 1000 may be desirably controlled electrically such as by a control module or other suitable electronic control means that control application of a suitable electrical voltage to the actuator segments, so that the movement of the exoskeleton 1000 may be controlled to provide a desired movement in response to inputs from the user such as for assisting a user's wrist movement or providing rehabilitative movement to the user's wrist with two degrees of freedom.

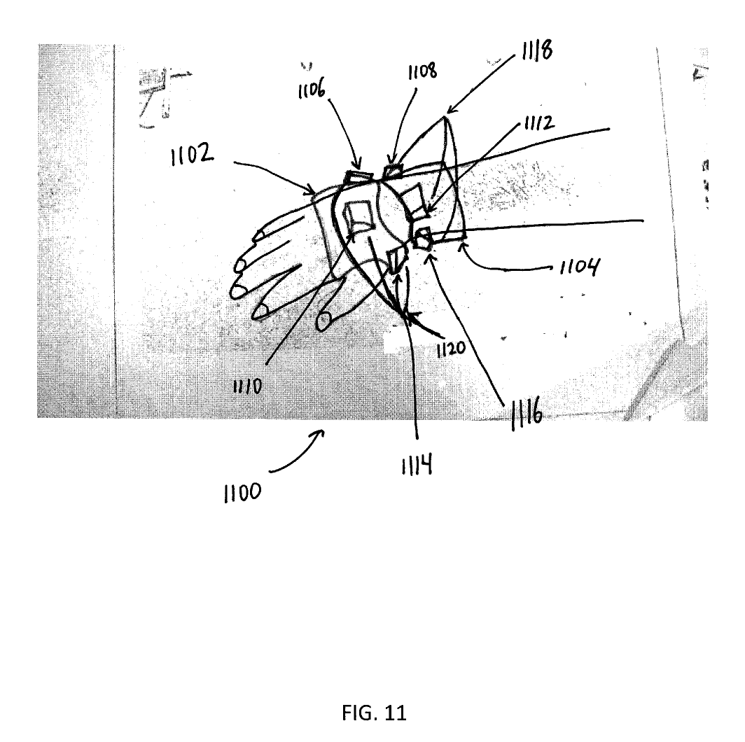

FIG. 11 is a perspective view of a wrist exoskeleton apparatus 1100 comprising a plurality of electromagnet elements 1110, according to an alternative embodiment of the invention. Similar to as shown in the embodiment of FIG. 10 as described above, wrist exoskeleton apparatus 1100 comprises a hand brace member 1102 and a wrist or forearm brace member 1104 and provides for controlled movement of the hand brace member 1102 relative to the wrist or forearm brace member 1104 with two degrees of freedom corresponding to deviation in the radial/ulnar directions, and flexion/extension of the wrist joint.

In the present embodiment, in place of the actuator segments used in the embodiment of FIG. 10, hand brace member 1102 is not directly connected to the wrist or forearm brace member 1104, but rather is moved relative to the wrist/forearm brace 1104 by a plurality of pairs of electromagnets 1110/1112, 11106/1108, and 1114/1116. For each cooperating pair of electromagnets such as 1110/1112, one of the electromagnets 1110 is attached to the hand brace 1102 and the other electromagnet 1112 of the pair is attached to the wrist/forearm brace 1104, so that the application of an electrical current to the electromagnet pair 1110/1112 may alternately provide an attractive and/or repulsive magnetic force between the hand and wrist/forearm braces, depending upon the direction/polarity of the current in the electromagnets. Desirably, one or more electromagnet pairs 1110/1112 may be located above and below the hand brace element 1102 so that coordinated attraction of the upper (dorsal) electromagnet pair and repulsion of the lower (ventral) electromagnet pair may provide extension movement of the hand brace 1102, while attraction of the lower (ventral) pair and repulsion of the upper (dorsal) pair may provide flexion movement of the hand brace 1102. Similarly, one or more pairs of electromagnets 1106/1108 and 1114/1116 may desirably be located to either side of the hand brace 1102 and electromagnetic attraction and repulsion in opposition may desirably provide radial/ulnar deviation movement of the hand brace 1102 relative to the wrist/forearm brace 1104.

Similar to the embodiments above, the alternate electromagnetic attraction and repulsion of the electromagnet pairs 1106/1108, 1110/1112, and 1114/1116 by application of electrical current to the electromagnet pairs, thereby providing flexion/extension and radial/ulnar deviation movements of the wrist exoskeleton 1100 may be desirably controlled electrically such as by a control module or other suitable electronic control means that control application of a suitable electrical voltage to the actuator segments, so that the movement of the exoskeleton 1100 may be controlled to provide a desired movement in response to inputs from the user such as for assisting a user's wrist movement or providing rehabilitative movement to the user's wrist with two degrees of freedom.

In an optional embodiment, one or more of the magnetic elements attached to the hand brace element 1102, such as magnets 1106, 1110 and 1114 for example, may be permanent magnets instead of electromagnets. In such an embodiment, the permanent magnets on the hand brace 1102 may interact with corresponding electromagnet elements on the wrist brace 1104 which are electrically controlled to control attraction and repulsion forces between the pairs.

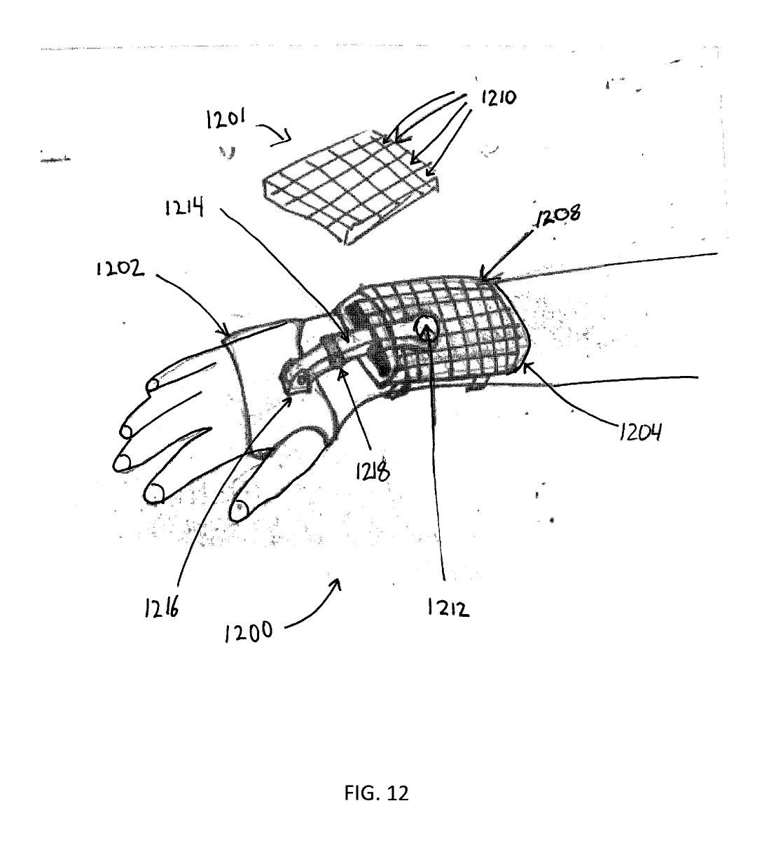

FIG. 12 illustrates a perspective view of a wrist exoskeleton apparatus 1200 comprising a plurality of electromagnetic tile elements 1210 according to an embodiment of the invention. Similar to as described in the embodiments shown in FIG. 8 above, wrist exoskeleton apparatus 1200 comprises a hand brace member 1202 and a forearm brace member 1204 and provides for controlled movement of the hand brace member 1202 relative to the wrist or forearm brace member 1204 with two degrees of freedom corresponding to deviation in the radial/ulnar directions, and flexion/extension of the wrist joint. Similar to as above described, hand brace member 1202 may desirably be adapted for wearing on or around the hand of a user, while the wrist or forearm brace member 1204 may be attached to or worn on the lower forearm or wrist of the user, such as slightly above the center of the wrist joint, such as is shown in FIG. 12.

The hand brace member 1202 is connected to the wrist or forearm brace member 1204 by a link member 1214 which has a revolute or hinged joint 1218 so as to provide a curved shape, and is hingedly connected to hand anchor 1216 which is attached to the hand brace member 1202. The opposite end of the link member 1214 comprises a ferromagnetic element 1212 which interacts with and is constrained within the boundaries of an electromagnetic plate 1208 which is attached to the wrist/forearm brace 1204. As shown in inset view 1201, the electromagnetic plate 1208 comprises a grid-like array of electromagnetic tiles 1210 which may be independently electromagnetically controlled, such as by activating or deactivating an electrical current within the tile 1210 to activate or deactivate an electromagnetic field. Accordingly, when an electrical current is activated in a particular tile 1210, the ferromagnetic element 1212 of link member 1214 is attracted to the activated tile 1210 and may desirably be moved towards the location of the particular activated tile 1210. Therefore, by controlling the activation and deactivation of electromagnetic tiles 1210 on the plate 1208, the link member 1214 may be controllably moved to provide for movement in directions corresponding to flexion/extension of the wrist joint via movements of ferromagnetic element 1212 upwards or downwards along the forearm, and radial/ulnar deviation of the wrist joint via movement of the ferromagnetic element 1212 laterally across the forearm of the user, as may be used in an assistive motion and/or rehabilitative motion applications such as are described above in reference to other embodiments.

The control of the electromagnetic tiles 1210 to provide flexion/extension and radial/ulnar deviation movements of the wrist exoskeleton 1200 may be desirably controlled electrically such as by a control module or other suitable electronic control means, so that the movement of the exoskeleton 1200 may be controlled to provide a desired movement in response to inputs from the user such as for assisting a user's wrist movement or providing rehabilitative movement to the user's wrist with two degrees of freedom.

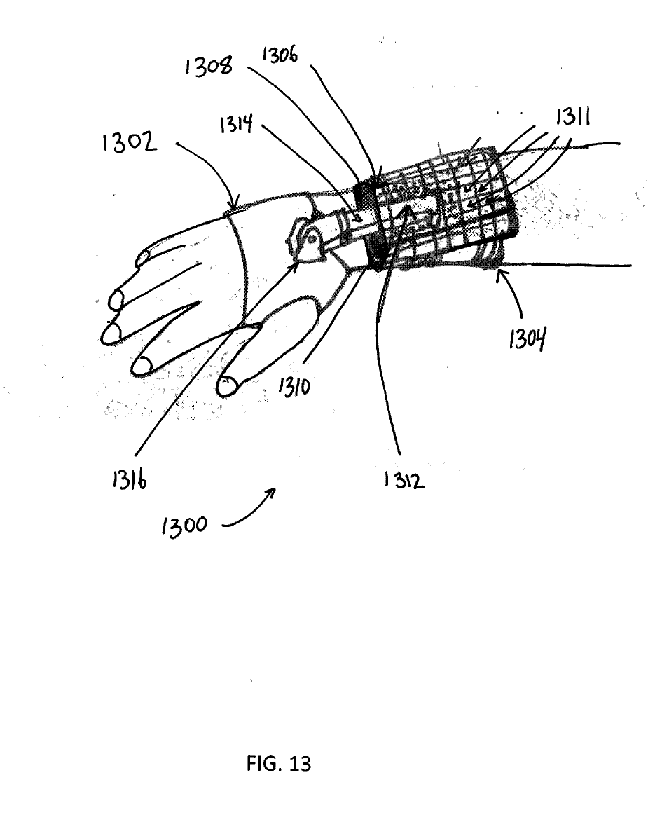

FIG. 13 illustrates a perspective view of a wrist exoskeleton apparatus 1300 comprising a magnetorheological fluid 1308 according to a further embodiment of the invention. Similar to as shown in FIG. 12 and described immediately above, wrist exoskeleton apparatus 1300 comprises a hand brace member 1302 and a forearm brace member 1304 and provides for controlled movement of the hand brace member 1302 relative to the wrist or forearm brace member 1304 with two degrees of freedom corresponding to deviation in the radial/ulnar directions, and flexion/extension of the wrist joint. Similar to as above described, hand brace member 1302 may desirably be adapted for wearing on or around the hand of a user, while the wrist or forearm brace member 1304 may be attached to or worn on the lower forearm or wrist of the user.

The hand brace member 1302 is connected to the wrist or forearm brace member 1304 by a link member 1314 which is hingedly connected at a revolute or hinged joint to hand anchor 1316 which is attached to the hand brace member 1302. The opposite end of the link member 1314 comprises a moveable head portion 1312 which is constrained within the boundaries of a box or compartment attached to the wrist/forearm brace 1304, which comprises a top and bottom electromagnetic plates 1306 and 1310 which each comprise a gird-like array of individually controllable electromagnetic tiles 1311 (similar to tiles 1210 as described above, and which is filled with a magnetorheological smart fluid 1308. As is known in the field of smartfluids, magnetorheological smart fluid 1308 is operable to change in viscosity under the influence of a magnetic field, to become a viscoelastic solid, so that by application of a magnetic field between corresponding electromagnetic tiles 1311 on top and bottom plates 1306 and 1310 respectively, and by moving the magnetic field by activating adjacent electromagnetic tiles in a continuous pattern, a moving force may be transferred to the moveable head portion 1312 of link member 1314 and the force may thereby be transferred to the hand brace 1302 to provide controllable movement thereof. In the present embodiment, the container or box is desirably sealed around the link member shaft 1314 where it enters the box, in order to prevent leakage or loss of the smartfluid 1308. In an alternative embodiment, the smart fluid may comprise an electrorheological fluid, and in such an embodiment, top and bottom plates 1306 and 1310 may comprise electro tiles 1311 which are effective to produce an electrical field within the container to control the viscosity of the electrorheological fluid 1308.

Therefore, by controlling the activation and deactivation of electromagnetic tiles 1311 on top and bottom plates 1306 and 1310, the link member 1314 may be controllably moved to provide for movement of hand brace 1302 in directions corresponding to flexion/extension of the wrist joint via movements of link member 1314 upwards or downwards along the forearm, and radial/ulnar deviation of the wrist joint via movement of the link member 1314 laterally across the forearm of the user, as may be used in an assistive motion and/or rehabilitative motion applications such as are described above in reference to other embodiments.

The control of the electromagnetic tiles 1311 to provide flexion/extension and radial/ulnar deviation movements of the wrist exoskeleton 1300 may be desirably controlled electrically such as by a control module or other suitable electronic control means, so that the movement of the exoskeleton 1300 may be controlled to provide a desired movement in response to inputs from the user such as for assisting a user's wrist movement or providing rehabilitative movement to the user's wrist with two degrees of freedom.

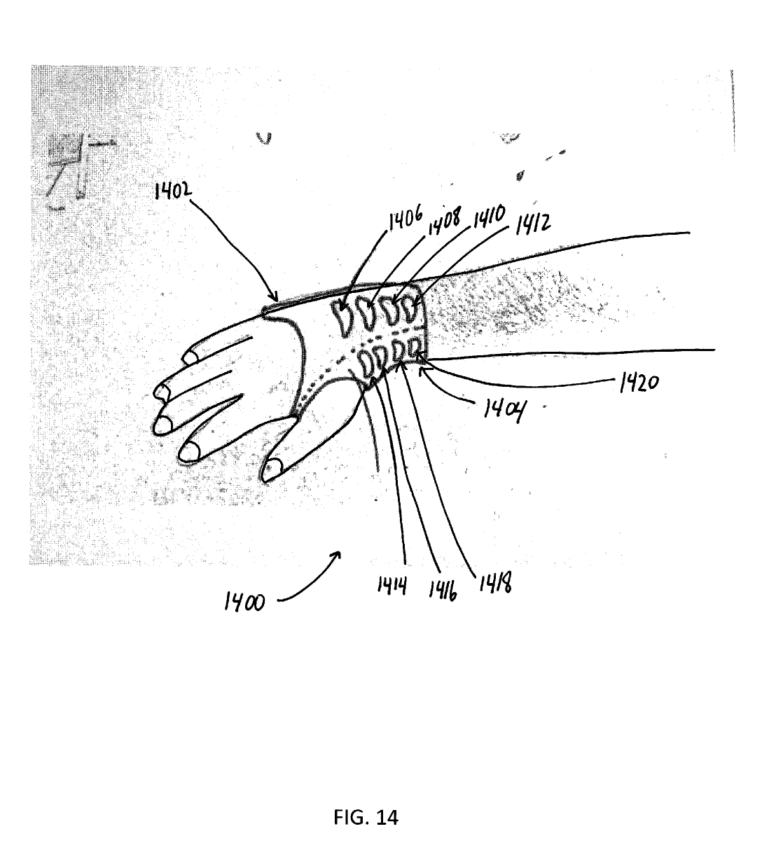

FIG. 14 illustrates a perspective view of a wrist exoskeleton apparatus 1400 comprising a plurality of integrated electromagnet elements, such as element 1406, according to an embodiment of the invention. Similar to as shown in the embodiment of FIG. 11 as described above, wrist exoskeleton apparatus 1400 comprises a hand brace member 1402 and a wrist or forearm brace member 1404 and provides for controlled movement of the hand brace member 1402 relative to the wrist or forearm brace member 1404 with two degrees of freedom corresponding to deviation in the radial/ulnar directions, and flexion/extension of the wrist joint.

In the present embodiment, in place of the isolated pairs of electromagnets used to move the hand brace relative to the wrist/forearm brace in the embodiment of FIG. 11, hand brace member 1402 may be connected to wrist/forearm brace 1404 as a single flexible brace unit 1400, such as a single substantially cylindrical flexible wrist brace or glove 1400, which may optionally also be elastic in nature. The hand brace portion 1402 of the apparatus 1400 is moved relative to the wrist/forearm brace portion 1404 by a plurality of sets of electromagnet elements, such as a first set of electromagnets 1406, 1408, 1410, and 1412, and a second set of electromagnets 1414, 1416, 1418 and 1420. For each cooperating set of electromagnets, the electromagnet elements are spaced out along the brace/glove 1400 extending from the hand brace portion 1402, towards the wrist/forearm brace portion 1404, such as from electromagnet 1406 to 1410, so that the application of an electrical current to the electromagnets in the set may alternately provide either an attractive and/or repulsive magnetic force between the electromagnets in the set, depending upon the direction/polarity of the current in the electromagnets. Desirably, one or more electromagnet sets such as 1406/1408/1410/1412 may be located above (dorsally) and below (ventrally) the wrist brace apparatus 1400 so that coordinated attraction of the upper electromagnet set and repulsion of the lower electromagnet set may provide extension movement of the hand brace 1402, while attraction of the lower set and repulsion of the upper set may provide flexion movement of the hand brace 1402. Similarly, one or more sets of electromagnets such as 1414/1416/1418/1420 may desirably be located to either side of the hand brace 1402 and electromagnetic attraction and repulsion in opposition may desirably provide radial/ulnar deviation movement of the hand brace portion 1402 relative to the wrist/forearm brace portion 1404.

Similar to the embodiments above, the alternate electromagnetic attraction and repulsion of the electromagnet sets 1406/1408/1410/1412 and 1414/1416/1418/1420 by application of electrical current to the electromagnet elements, thereby providing flexion/extension and radial/ulnar deviation movements of the wrist exoskeleton 1400 may be desirably controlled electrically such as by a control module or other suitable electronic control means that control application of a suitable electrical current to the electromagnet segments, so that the movement of the exoskeleton 1400 may be controlled to provide a desired movement in response to inputs from the user such as for assisting a user's wrist movement or providing rehabilitative movement to the user's wrist with two degrees of freedom.

In an optional embodiment, each set of electromagnets may comprise any suitable number of individual electromagnetic elements, as may be convenient or advantageous for providing for control of flexion/extension and radial/ulnar deviation movements of the wrist exoskeleton apparatus 1400. In a preferred embodiment, each set of electromagnets may comprise between about three to five individual electromagnetic elements. In all such embodiments, the particular number of electromagnets may be selected as suitable and needed to provide the desired amount of force and/or extent of movement required for the brace apparatus 1400, such as for assistive and/or rehabilitative movement applications, for example.

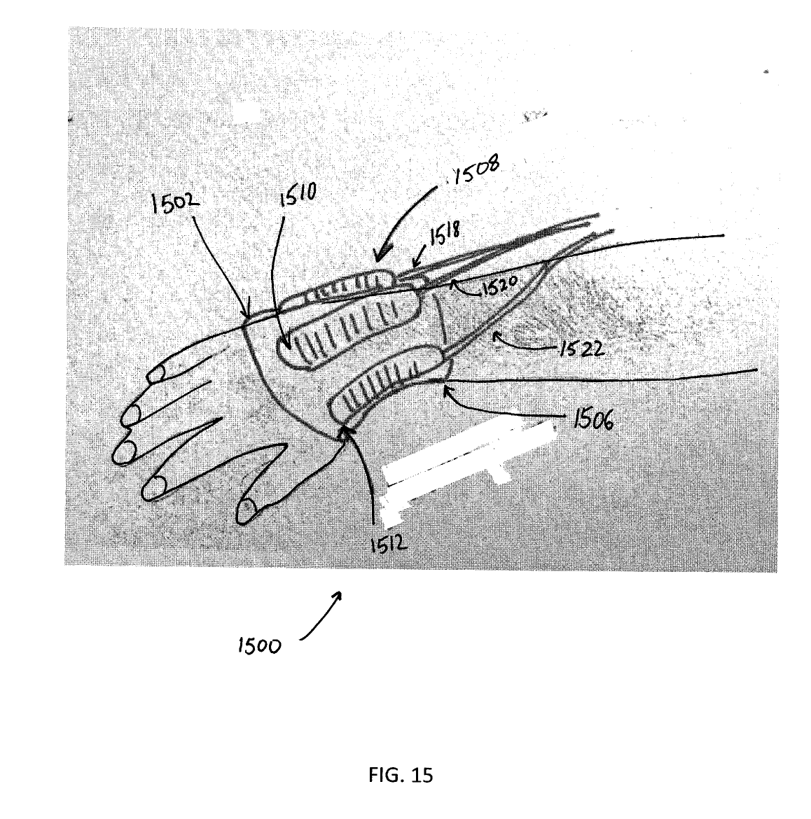

FIG. 15 illustrates a perspective view of a wrist exoskeleton apparatus 1500 comprising a plurality of fluidic actuators 1506, 1508, and 1510, according to another embodiment of the invention. Similar to as shown in the embodiment of FIG. 14 as described above, wrist exoskeleton apparatus 1500 comprises a hand brace portion 1502 and a wrist or forearm brace portion 1504 of a single flexible brace unit 1500, such as a single substantially cylindrical flexible wrist brace or glove 1500. The unitary wrist exoskeleton apparatus 1500 desirably provides for controlled movement of the hand brace portion 1502 relative to the wrist or forearm brace portion 1504 with two degrees of freedom corresponding to deviation in the radial/ulnar directions, and flexion/extension of the wrist joint.

In the present embodiment, in place of the sets of electromagnets used to move the hand brace relative to the wrist/forearm brace in the embodiment of FIG. 14, hand brace portion 1502 may be connected to wrist/forearm brace portion 1504 and may also be moved relative to the wrist/forearm brace portion 1504 by a plurality of micro-fluid actuators 1506, 1508, and 1510, for example. Each micro-fluid actuator is located along the central wrist portion of the brace/glove 1500 extending from the hand brace portion 1402, towards the wrist/forearm brace portion 1504, so that the actuator is activated by an increase of fluid pressure within the micro-fluid actuator, the actuator will bend or deform outward, thus pulling on the hand brace portion 1502 of the brace/glove 1500 adjacent to the actuator, and thereby act to move the hand brace portion 1502 relative to the wrist/forearm brace portion 1504, depending on the particular actuator activated and the magnitude of the pressure increase applied to a fluid inside the micro-fluid actuator. In one embodiment, the fluid pressure inside each individual actuator 1506, 1508 and 1510 may be independently controllable, such as by increasing and/or decreasing the volume of fluid inside the micro-fluid actuator through corresponding individual fluid conduits 1522, 1518 and 1520, respectively, for example.

Desirably, one or more micro-fluidic actuator such as actuator 1510 may be located above (dorsally) and below (ventrally) the wrist brace apparatus 1500 so that coordinated increase of pressure in the upper micro-fluidic actuator and decrease of pressure in the lower micro-fluidic actuator may provide extension movement of the hand brace portion 1502, while decreasing pressure in the lower actuator and increasing pressure in the lower actuator may provide flexion movement of the hand brace portion 1502. Similarly, one or more micro-fluidic actuator such as actuator 1506 and/or 1508 may desirably be located to either side of the hand brace portion 1502 and increasing and/or decreasing internal pressure in the actuators in opposition may desirably provide radial/ulnar deviation movement of the hand brace portion 1502 relative to the wrist/forearm brace portion 1504.

Similar to the embodiments above, increasing and decreasing of the fluid pressure within the micro-fluidic actuators 1506, 1508 and/or 1510 such as by controlling the volume of fluid within the actuators, thereby providing flexion/extension and radial/ulnar deviation movements of the wrist exoskeleton 1500 may be desirably controlled electrically such as through the control of an electronic micro-pump means for example. Such electrical control may be accomplished by a control module or other suitable electronic control means that control operation of the pump means, so that the movement of the exoskeleton 1500 may be controlled to provide a desired movement in response to inputs from the user such as for assisting a user's wrist movement or providing rehabilitative movement to the user's wrist with two degrees of freedom.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

1. A wrist exoskeleton, comprising:
a first means for imparting motion on a wrist of a user in a first degree of freedom corresponding to a flexion/extension of the wrist;
a second means for imparting motion on the wrist of the user in a second degree of freedom corresponding to a radial/ulnar deviation motion of the wrist; and
a hand support adapted to be worn on a hand of the user corresponding to the wrist;
wherein said hand support and said first and second means for imparting motion on the wrist of the user in the first and second degrees of freedom interoperate with each other in a manner that permits the pronation and supination motion of a same forearm of the user corresponding to the wrist.

2. The wrist exoskeleton according to claim 1, additionally comprising a forearm support, wherein said forearm support is adapted for removable attachment to at least one of a forearm and a wrist of a user;
wherein said hand support is adapted for removable attachment to a same hand of the user corresponding to the forearm; and
wherein said first means for imparting motion on the wrist of the user in the first degree of freedom comprises at least one first actuator for imparting motion on the wrist of the user corresponding to the forearm in the first degree of freedom; and
wherein said second means for imparting motion on the wrist of the user in the second degree of freedom comprises at least one second actuator for imparting motion on the wrist of the user in the second degree of freedom.

3. The wrist exoskeleton according to claim 2, wherein said at least one first actuator comprises a first linear actuator rotatably mounted on a top surface of said forearm support, and said at least one second actuator comprises a second linear actuator rotatably mounted substantially on a lateral surface of said forearm support; and
wherein said first and second linear actuators are configured to deliver respective first and second external forces to said hand support.

4. The wrist exoskeleton according to claim 3 wherein a rotation axis of said second linear actuator is substantially aligned with a first rotation axis of said wrist of the user corresponding to the radial/ulnar deviation motion of the wrist of the user; and a rotation axis of said first linear actuator is substantially aligned with a second rotation axis of said wrist of the user corresponding to the flexion/extension motion of said wrist of the user.

5. The wrist exoskeleton according to claim 4, wherein said first means for imparting motion on the wrist of the user in the first degree of freedom additionally comprises a first mechanical link for transferring an external applied force delivered by the first linear actuator into a first torque acting on said hand support, and wherein said second means for imparting motion of the wrist of the user in the second degree of freedom additionally comprises a second mechanical link for transferring an external applied force delivered by the second linear actuator into a second torque acting on said hand support.

6. The wrist exoskeleton according to claim 2, wherein said at least one first actuator comprises a first linear actuator, and said at least one second actuator comprises a gear motor;
wherein said gear motor is rotatably coupled on a first end to an arc-shaped disk mounted on a top surface of said forearm support and connected to said first linear actuator on a second end thereof;
wherein said linear actuator is rotatably coupled on a first end to said arc-shaped disk through said gear motor and mounted on said hand support on a second end thereof; and
wherein when said gear motor is actuated, a corresponding torque generated thereby causes a spur gear of said gear motor to rotate about and along an arc of said arc-shaped disk and said first linear actuator to rotate about the same, whereby said first linear actuator is operable to impart said radial/ulnar deviation motion of the wrist of the user.

7. The wrist exoskeleton according to claim 3, wherein said at least one first actuator comprises a first gear motor, and said at least one second actuator comprises a second gear motor, wherein said first gear motor and said second gear motor are mounted on a moveable base, a first end of which is slidably engaged with and rotatable along a groove of an arc-shaped disk disposed on said forearm support; and
wherein when said first gear motor is actuated, a corresponding torque generated thereby causes said moveable base to rotate about and along said groove of said arc-shaped disk, whereby a resulting motion of said moveable base is operable to impart said radial/ulnar deviation motion of the wrist of the user.

8. The wrist exoskeleton according to claim 2, wherein said first actuator comprises a linear actuator for imparting a flexion/extension motion to the wrist of the user; and wherein said second actuator comprises a rotating disk attached to said forearm support and operable to be rotatably driven by a gear motor for imparting a radial/ulnar deviation motion to the wrist of the user; and wherein said linear actuator is attached to said rotating disk.

9. The wrist exoskeleton according to claim 2, wherein said first actuator comprises a first articulated link attached to said hand support and said forearm support and powered by a first linear actuator for imparting a flexion/extension motion to the wrist of the user; wherein said second actuator comprises a second articulated link attached to said hand support and said forearm support and powered by a second linear actuator for imparting a radial/ulnar deviation motion to the wrist of the user; and wherein said second articulated link is oriented substantially perpendicularly to said first link.

10. The wrist exoskeleton according to claim 1, additionally comprising a forearm support, wherein said forearm support is adapted for removable attachment to at least one of a forearm and a wrist of a user; wherein said hand support comprises a substantially spherical curved surface; and wherein said first and second means for imparting motion on the wrist of the user in the first and second degrees of freedom comprise a pair of first and second rotary motors with drive wheels engaging said substantially spherical curved surface of said hand support.

11. The wrist exoskeleton according to claim 2, additionally comprising a flexible articulating structure comprising a plurality of interconnected links extending between said hand support and said forearm support, and wherein said first actuator comprises at least one linear actuator adapted to apply a tensile force to said plurality of interconnected links in a first direction for imparting a flexion/extension motion to the wrist of the user; and wherein said second actuator comprises at least one linear actuator adapted to apply a tensile force to said plurality of interconnected links in a second direction for imparting a radial/ulnar deviation motion to the wrist of the user.

12. The wrist exoskeleton according to claim 2, additionally comprising a plurality of shape memory alloy strips extending between said hand support and said forearm support, and wherein said first actuator comprises at least one said shape memory alloy strip attached substantially on top of said forearm and hand supports adapted to apply a tensile force upon heating actuation for imparting a flexion/extension motion to the wrist of the user; and wherein said second actuator comprises at least one said shape memory alloy strip attached substantially at a side of said forearm and hand supports adapted to apply a tensile force upon heating actuation for imparting a radial/ulnar deviation motion to the wrist of the user.

13. The wrist exoskeleton according to claim 2, additionally comprising a plurality of piezoelectric and/or electroactive polymer actuator elements extending between said hand support and said forearm support, and wherein said first actuator comprises at least one said piezoelectric and/or electroactive polymer actuator element attached substantially on top of said forearm and hand supports adapted to apply a tensile force upon electrical actuation for imparting a flexion/extension motion to the wrist of the user; and wherein said second actuator comprises at least one said piezoelectric and/or electroactive polymer actuator element attached substantially at a side of said forearm and hand supports adapted to apply a tensile force upon electrical actuation for imparting a radial/ulnar deviation motion to the wrist of the user.

14. The wrist exoskeleton according to claim 2, additionally comprising a plurality of pairs of electromagnets installed between said hand support and said forearm support, and wherein said first actuator comprises at least one said pair of electromagnets attached substantially on top of said forearm and hand supports adapted to apply an attractive or repulsive force upon electrical actuation for imparting a flexion/extension motion to the wrist of the user; and wherein said second actuator comprises at least one said pair of electromagnets attached substantially at a side of said forearm and hand supports adapted to apply an attractive or repulsive force upon electrical actuation for imparting a radial/ulnar deviation motion to the wrist of the user.

15. The wrist exoskeleton according to claim 1, additionally comprising a forearm support, wherein said forearm support is adapted for removable attachment to at least one of a forearm and a wrist of a user and comprises an electromagnetic tile array; wherein said hand support comprises a hinged linking bar having a ferromagnetic end portion and extending between said hand support and said electromagnetic tile array of said forearm support; and wherein said first and second means for imparting motion on the wrist of the user in the first and second degrees of freedom comprise said hinged linking bar and said electromagnetic tile array adapted for moving said electromagnetic end across said electromagnetic tile array upon electrical actuation for imparting at least one a flexion/extension motion and a radial/ulnar deviation motion to the wrist of the user.

16. The wrist exoskeleton according to claim 15, additionally comprising a magnetorheological fluid contained in an enclosure attached to said forearm support formed by said electromagnetic tile array and a second upper electromagnetic tile array.

17. The wrist exoskeleton according to claim 1, wherein said first and second means for imparting motion on the wrist of the user in the first and second degrees of freedom each comprise at least one of:
a plurality of electromagnetic elements adapted to provide an attractive or repulsive force for imparting said motion; and
one or more micro-fluidic actuators adapted to provide an contractive or expansive force for imparting said motion.
